(19) United States
(12) Patent Application Publication
(10) Pub. No.: US 2026/0004281 A1
(43) Pub. Date: Jan. 1, 2026

(54) SYSTEMS AND METHODS FOR CUSTOMIZABLE TIPPING AND RECEIPT PREFERENCES FOR DIFFERENT TRANSACTION TYPES

(71) Applicant: Adeia Guides Inc., San Jose, CA (US)

(72) Inventors: Charles Dasher, Lawrenceville, GA (US); Reda Harb, Tampa, FL (US); Serhad Doken, Bryn Mawr, PA (US)

(21) Appl. No.: 18/758,862

(22) Filed: Jun. 28, 2024

(51) Int. Cl. G06Q 20/36; G06Q 20/20; G06Q 20/34; G06Q 20/38

(52) U.S. Cl. CPC G06Q 20/3674; G06Q 20/385; G06Q 20/20; G06Q 20/34

(57) ABSTRACT

Systems and methods are provided herein for a customizable digital wallet system that enables users to set their own preferences. This may be accomplished by a digital wallet profile receiving characteristics corresponding to one or more transaction types preferences related to the one or more transaction types. The system may receive a payment request comprising information about a purchase. The system can determine a transaction type of the purchase by comparing the information about the purchase with the received characteristics. The system then identifies preferences related to the determined transaction type. One or more preferences of the identified preferences are then used to complete the purchase.

### BACKGROUND

The present disclosure relates to digital transactions, and in particular to techniques for customizing payment preferences related to digital transactions.

### SUMMARY

The increasing prevalence of tipping prompts at payment terminals across various service industries, even where tipping has not traditionally been expected, can create challenges and discomfort for consumers. For example, digital payment systems often prompt consumers to leave a tip by presenting pre-calculated percentages or custom amounts just before completing the transaction. These types of prompts can cause discomfort for the customers, particularly in situations where the consumers might not think a tip is warranted but feel obligated to comply due to the presence of staff or other consumers. The visibility of tipping prompts can exacerbate consumer's feelings of obligation, which can lead to discomfort, resentful compliance, and a degraded consumer experience.

Tipping fatigue is another consequence of the increasing prevalence of tipping prompts. Consumers who encounter tipping options in many locations (e.g., coffee shops, fast-food restaurants, retail shops, healthcare locations, etc.) might begin to feel overwhelmed or annoyed. The increasing prevalence of tipping prompts can lead to a dilution of the tipping practice, where the gesture of leaving a gratuity as a reward for exceptional service becomes a routine, almost thoughtless act. Additionally, the integration of tipping prompts in digital transactions can sometimes lead to confusion, especially when the purpose of the tip is unclear. For example, interaction with restaurant staff is minimal in the fast-food restaurant environment, so the purpose of the tip in the fast-food restaurant environment is unclear. Customers may question the appropriateness of tipping in such contexts and when confronted with a tipping option, they might struggle to decide how much to tip, or whether to tip at all. These situations can lead to an unsatisfactory consumer experience.

The increase in digital transactions has also changed the way receipts are handled. The digitalization of receipts, while convenient and environmentally friendly, introduces new dynamics and potential issues. For example, customers may be required to enter their email addresses at the point of sale, which can slow down transactions and lead to queues, especially in high-traffic retail environments. This requirement can also raise privacy concerns, as customers may be hesitant to share personal information due to fears of receiving unwanted marketing emails or potential data breaches. Moreover, the integration of digital receipts into the payment process often comes after the tipping prompt, which can lead to a compounded experience of input requests. The compounded input requests can frustrate customers, especially if they are in a hurry or if they perceive these steps as unnecessary for their transaction types.

Accordingly, techniques are disclosed herein for a customizable digital wallet system that enables users to set their own preferences. A user may create a digital wallet profile using one or more devices (e.g., smartphone, laptop, desktop, etc.). When creating a digital wallet profile, the user may input one or more preferences relating to transactions. For example, a first preference may indicate a first tipping percentage (e.g., 25%) for a first location type (e.g., sit-down restaurant) and a second preference may indicate a second tipping percentage (e.g., 5%) for a second location type (e.g., fast-food restaurant). In another example, a first preference may indicate a first receipt preference (e.g., digital receipt sent to a first email address) for a first location type (e.g., restaurants) and a second preference may indicate a second receipt preference (e.g., digital receipt sent to a second email address) for a second location type (e.g., retail stores). In another example, a first preference may indicate a first payment method (e.g., personal credit card) for a first transaction type (e.g., personal transaction) and a second preference may indicate a second payment method (e.g., business credit card) for a second transaction type (e.g., business transaction).

A user may implement the digital wallet system by using their device and/or credit card to complete a purchase. For example, a waiter at a restaurant may input the price of a meal into a point-of-sale (POS) terminal. The user's device may transmit (e.g., via a near-field communication (NFC) protocol) a digital wallet profile identifier to the POS terminal to pay for the meal. The POS terminal may then transmit a payment request comprising the digital wallet profile identifier to one or more devices (e.g., digital wallet servers). The digital wallet system can identify the digital wallet profile of the user based on the digital wallet profile identifier. The digital wallet system may then transmit a payment confirmation to the POS terminal, wherein the payment confirmation comprises payment information (e.g., credit card information, transaction token, etc.) and a transaction code. The payment information may be based on one or more of the stored preferences. For example, the user may have a first preference indicating a first payment method (e.g., first credit card) for a first location type (e.g., restaurants) and a second preference indicating a second payment method (e.g., second credit card) for a second location type (e.g., retail stores).

The POS terminal may then display a payment authorization and tip request based on receiving the payment information and the transaction code from the digital wallet system. To confirm the payment authorization and initiate tipping, the user's device may transmit (e.g., via the near-field communication protocol) a payment authorization to the POS terminal to pay for a tip. The POS terminal may then transmit a tip request comprising the digital wallet profile identifier and the transaction code to the one or more devices (e.g., digital wallet servers) in response to receiving the payment authorization from the user's device. The digital wallet system can determine that the tip request is associated with the previous payment request based on the transaction code. The digital wallet system may then identify a tipping percentage using the digital wallet profile identifier and then calculate the tip based on the tipping percentage. The tipping percentage may be based on one or more of the stored preferences. For example, a first preference may indicate a first tipping percentage (e.g., 25%) for a first location type (e.g., sit-down restaurant) and a second preference may indicate a second tipping percentage (e.g., 5%) for a second location type (e.g., fast-food restaurant). The digital wallet system may then transmit payment information, the tip amount, and the transaction code to the POS terminal.

The POS terminal can use the payment information, tip amount, and transaction code, received from the digital wallet system, to complete the transaction. In some embodiments, the POS terminal requests (e.g., via an application programming interface (API) call) a batch authorization of the purchase amount and the tip amount to a payment processor based on the transaction code. For example, the POS terminal queues any pending API calls in its memory until the POS terminal has all the information to make one or a single HTTP request that includes multiple API calls in order to reduce overhead (when making separate API request through different HTTP connections). The POS terminal can also transmit one or more digital receipts based on one or more preferences received from the digital wallet system. For example, a first preference may indicate a first receipt preference (e.g., digital receipt sent to the digital wallet system) for a first location type (e.g., restaurants) and a second preference may indicate a second receipt preference (e.g., digital receipt sent to an email address) for a second location type (e.g., retail stores).

The digital wallet system can also facilitate the tracking of business expenses. For example, a user may have an upcoming business trip to Texas. The user may input one or more transaction characteristics (e.g., location, time, etc.) and one or more business preferences associated with the upcoming business trip into their digital wallet profile. In some embodiments, a trip identifier related to the upcoming business trip is automatically generated by one or more booking services (e.g., Expedia, online travel management/booking solutions, etc.). When the user uses their digital wallet profile to pay for a purchase on the business trip, the digital wallet system automatically tracks the business expense using the transaction characteristics. For example, a user may use their device to transmit (e.g., via a near-field communication protocol) their digital wallet profile identifier to a POS terminal to pay for a purchase on the business trip. The POS terminal may then transmit a payment request comprising the digital wallet profile identifier and one or more purchase characteristics (e.g., location, time, etc.) to the digital wallet system. The digital wallet system can identify the digital wallet profile of the user based on the digital wallet profile identifier. The digital wallet system can also determine that the purchase associated with the payment request corresponds to a business expense based on one or more of the purchase characteristics matching one or more of the transaction characteristics associated with the business trip.

In response to the digital wallet system determining that the purchase is associated with the business expense, the digital wallet system can store a record of the purchase as a business expense. In some embodiments, the digital wallet system transmits a receipt associated with the business expense purchase to one or more devices (e.g., corporate expense system) identified in the one or more business preferences inputted by the user. In response to the digital wallet system determining that the purchase is associated with the business expense, the digital wallet system can also transmit a payment confirmation to the POS terminal, wherein the payment confirmation comprises payment information (e.g., credit card information, transaction token, etc.). The payment information may be based on one or more of the stored business preferences. For example, the user may have a first business preference indicating a first payment method (e.g., business credit card) for purchases associated with a first location type (e.g., Texas). The digital wallet system may also transmit one or more receipt preferences to the POS terminal based on identifying that the purchase is a business expense. For example, a first preference may indicate a receipt preference (e.g., digital receipt sent to a business email address) for purchases associate with a first location type (e.g., Texas).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative flowchart of a process for providing a customizable digital wallet system that enables users to set their own preferences, in accordance with some embodiments of the disclosure.

FIG. 2 shows another illustrative flowchart of a process for providing a customizable digital wallet system that enables users to set their own preferences, in accordance with some embodiments of the disclosure.

FIGS. 3A and 3B show illustrative diagrams of user interfaces associated with a digital wallet system, in accordance with some embodiments of this disclosure.

FIG. 4 shows another illustrative flowchart of a process for providing a customizable digital wallet system that enables users to set their own preferences, in accordance with some embodiments of the disclosure.

FIG. 5 shows another illustrative flowchart of a process for providing a customizable digital wallet system that enables users to set their own preferences, in accordance with some embodiments of the disclosure.

FIG. 6 shows another illustrative flowchart of a process for providing a customizable digital wallet system that enables users to set their own preferences, in accordance with some embodiments of the disclosure.

FIG. 7 shows another illustrative flowchart of a process for providing a customizable digital wallet system that enables users to set their own preferences, in accordance with some embodiments of the disclosure.

FIG. 8 shows another illustrative flowchart of a process for providing a customizable digital wallet system that enables users to set their own preferences, in accordance with some embodiments of the disclosure.

FIG. 9 shows another illustrative flowchart of a process for providing a customizable digital wallet system that enables users to set their own preferences, in accordance with some embodiments of the disclosure.

FIG. 10 shows an illustrative diagram of another user interface associated with a digital wallet system, in accordance with some embodiments of this disclosure.

FIG. 11 shows an illustrative block diagram of a media system, in accordance with some embodiments of the disclosure.

FIG. 12 shows an illustrative block diagram of a user equipment device system, in accordance with some embodiments of the disclosure.

FIG. 13 shows an illustrative block diagram of a server system, in accordance with some embodiments of the disclosure.

### DETAILED DESCRIPTION

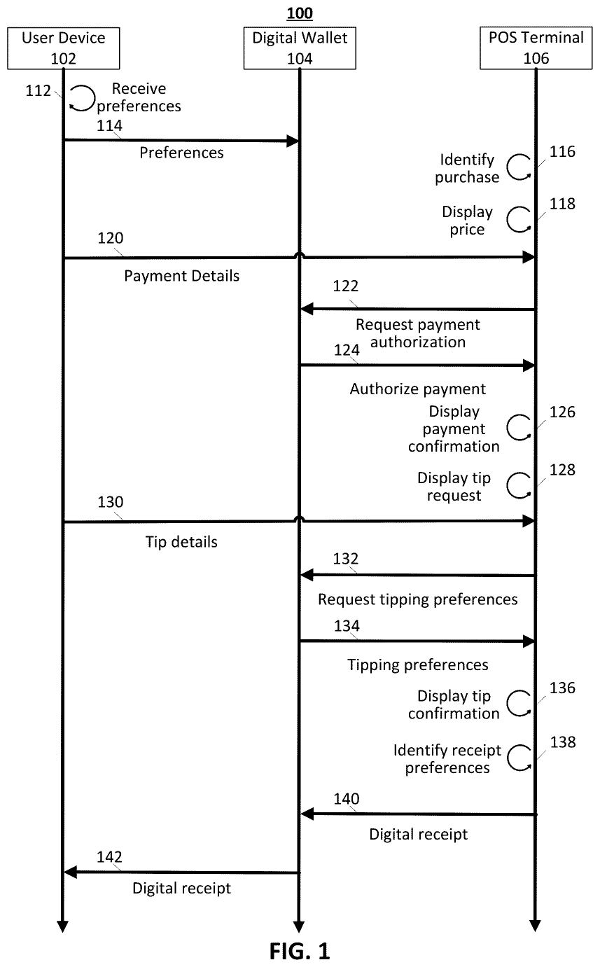

FIG. 1 shows an illustrative flowchart of a process 100 for providing a customizable digital wallet system that enables users to set their own preferences, in accordance with some embodiments of the disclosure. In some embodiments, some steps of process 100 may be performed by one of several devices. Although a user device 102, a digital wallet device 104, and a POS terminal 106 are shown, any number of servers and/or devices may be used. Further, different devices may perform different steps of the process 100 than what is shown. Although the process 100 is illustrated and described as a sequence of steps, it is contemplated that various embodiments of process 100 may be performed in any order or combination and need not include all the illustrated steps. In some embodiments, the digital wallet device 104 is a digital wallet server. In some embodiments, the user device 102 is a smartphone, laptop, desktop, and/or similar such device.

At step 112, the user device 102 receives a first set of preferences. In some embodiments, the user device 102 receives the first set of preferences based on one or more user inputs. For example, the user device 102 may comprise a user interface comprising selectable options. A user may input the first set of preferences by selecting one or more of the options. In some embodiments, the user device 102 receives the first set of preferences based on a user creating and/or updating a digital wallet profile. For example, the user device 102 may access the digital wallet device 104. The digital wallet device 104 may transmit one or more preference options to the user device 102.

In some embodiments, the first set of preferences comprise tipping preferences based on location, location type, payment method, transaction type, receipt preference, and/or similar such information. For example, a first preference may indicate a first tipping percentage (e.g., 25%) for a first location type (e.g., sit-down restaurant) and a second preference may indicate a second tipping percentage (e.g., 5%) for a second location type (e.g., fast-food restaurant). In another example, a first preference may indicate a first tipping percentage (e.g., 15%) for a first location type (e.g., Denny's) and a second preference may indicate a second tipping percentage (e.g., 25%) for a second location type (e.g., Longhorn Steak House). In another example, a first preference may indicate a first tipping method (e.g., first credit card) for a first transaction type (e.g., business transaction) and a second preference may indicate a second tipping method (e.g., second credit card) for a second transaction type (e.g., personal transaction).

In some embodiments, the first set of preferences comprise receipt preferences based on location, location type, payment method, transaction type, tipping preference, and/or similar such information. For example, a first preference may indicate a first receipt preference (e.g., digital receipt sent to a first email address) for a first location type (e.g., restaurants) and a second preference may indicate a second receipt preference (e.g., digital receipt sent to a second email address) for a second location type (e.g., retail stores). In another example, a first preference may indicate a first preference (e.g., digital receipt sent to a business email address) for a first transaction type (e.g., business transaction) and a second preference may indicate a second preference (e.g., digital receipt sent to a personal email address) for a second transaction type (e.g., personal transaction). At step 114, the user device 102 transmits the first set of preferences to the digital wallet device 104.

At step 116, the POS terminal 106 identifies a purchase. For example, a waiter at a restaurant may input the price of a meal into the POS terminal. At step 118, the POS terminal 106 displays the price of the purchase using one or more displays. In some embodiments, the POS terminal also displays a request for payment.

At step 120, the user device 102 transmits payment details to the POS terminal 106. In some embodiments, the user device 102 transmits payment details to the POS terminal 106 using a near-field communication protocol. For example, a user may tap the user device 102 on the POS terminal 106. In some embodiments, the user device 102 transmits payment details to the POS terminal 106 using the Internet, a mobile phone network, a mobile voice or data network (e.g., a 4G, 5G, or LTE network), a cable network, a public switched telephone network, or other types of communications network or combinations of communications networks. In some embodiments, the payment details comprise a digital wallet profile identifier and/or payment information. At step 122, the POS terminal 106 transmits a payment authorization request to the digital wallet device 104. In some embodiments, the payment authorization request comprises the digital wallet profile identifier and/or the payment information (e.g., credit card information, transaction token, etc.) received from the user device 102. In some embodiments, credit card information comprises the credit card's number, expiration date, Card Verification Value (CVV) code, and/or similar such information. In some embodiments, the transaction token corresponds to a representation of the credit card number (e.g., Device Account Number (DAN)).

At step 124, the digital wallet device 104 transmits a payment authorization to the POS terminal 106. In some embodiments, the digital wallet device 104 identifies the digital wallet profile associated with the user device 102 based on the digital wallet profile identifier received from the POS terminal 106. In some embodiments, the digital wallet device 104 identifies the digital wallet profile associated with the user device 102 based on the payment information received from the POS terminal 106. For example, the POS terminal 106 may transmit a first credit card number and the digital wallet device 104 may compare the first credit card number to a plurality of credit card numbers associated with a plurality of digital wallet profiles. The digital wallet device 104 may identify the digital wallet profile associated with the user device 102 based on the first credit card number matching one or more credit card numbers associated with the digital wallet profile associated with the user device 102.

In some embodiments, the payment authorization comprises payment information (e.g., credit card information, transaction token, etc.) and a transaction code. The payment information may be based on one or more of the stored preferences. For example, the digital wallet profile associated with the user device 102 may have a first preference indicating a first payment method (e.g., first credit card) for a first location type (e.g., restaurants) and a second preference indicating a second payment method (e.g., second credit card) for a second location type (e.g., retail stores). In some embodiments, the transaction code is generated by the digital wallet device 104 and is associated with the purchase and/or the digital wallet profile.

At step 126, the POS terminal 106 displays a payment confirmation. In some embodiments, the POS terminal 106 displays the payment confirmation in response to receiving a confirmation from one or more merchant services. For example, the POS terminal 106 may transmit credit card information received from the digital wallet device 104 and the purchase amount to a credit card processing service. The credit card processing service may process the credit card information and transmit a payment confirmation to the POS terminal 106.

At step 128, the POS terminal 106 displays a tip request associated with the purchase using the one or more displays. At step 130, the user device 102 transmits tip details to the POS terminal 106. In some embodiments, the user device 102 transmits tip details to the POS terminal 106 using a near-field communication protocol. For example, a user may again tap the user device 102 on the POS terminal 106. In some embodiments, the user device 102 transmits tip details to the POS terminal 106 using the Internet, a mobile phone network, a mobile voice or data network (e.g., a 4G, 5G, or LTE network), a cable network, a public switched telephone network, or other types of communications network or combinations of communications networks. In some embodiments, the tip details comprise the digital wallet profile identifier and/or payment information. At step 132, the POS terminal 106 transmits a tipping preference request to the digital wallet device 104. In some embodiments, the tipping preference request comprises the digital wallet profile identifier and/or the payment information (e.g., credit card information, transaction token, etc.) received from the user device 102. In some embodiments, the tipping preference request also comprises the transaction code.

At step 134, the digital wallet device 104 transmits the tipping preferences associated with the user device 102 to the POS terminal 106. In some embodiments, the digital wallet device 104 identifies the tipping preferences associated with the user device 102 based on the transaction code received from the POS terminal 106. For example, the transaction code may identify the digital wallet profile associated with the user device 102. In some embodiments, the digital wallet device 104 identifies the tipping preferences associated with the user device 102 based on the digital wallet profile identifier received from the POS terminal 106. In some embodiments, the digital wallet device 104 identifies the tipping preferences associated with the user device 102 based on the payment information received from the POS terminal 106. For example, the POS terminal 106 may transmit a first credit card number, and the digital wallet device 104 may compare the first credit card number to a plurality of credit card numbers associated with a plurality of digital wallet profiles. The digital wallet device 104 may identify the digital wallet profile associated with the user device 102 based on the first credit card number matching one or more credit card numbers associated with the digital wallet profile associated with the user device 102. The digital wallet device 104 may then identify the tipping preferences associated with the digital wallet profile.

In some embodiments, the tipping preferences comprise a tipping amount. The digital wallet device 104 may calculate a tipping amount using one or more tipping preferences. For example, the digital wallet profile may comprise a first preference indicating a first tipping percentage (e.g., 25%) for a first location type (e.g., sit-down restaurant). The purchase may correspond to a 100$ meal and the digital wallet device 104 may calculate (e.g., based on the first tipping preference) that the tipping amount should be 25$. In some embodiments, the digital wallet device 104 transmits the tipping amount (e.g., 25$) to the POS terminal 106.

In some embodiments, the tipping preferences comprises additional payment information (e.g., credit card information, transaction token, etc.), a tip amount, and a transaction code. In some embodiments, the additional payment information corresponds to a payment method for the tip amount. For example, the additional payment information may indicate that the same credit card that was used to pay for the purchase amount should be used to pay for the tip amount. In some embodiments, the additional payment information is based on one or more of the preferences associated with the digital wallet profile. For example, the digital wallet profile associated with the user device 102 may have a first preference indicating a first payment method (e.g., first credit card) for a first transaction type (e.g., purchases) and a second preference indicating a second payment method (e.g., second credit card) for a second transaction type (e.g., tips).

At step 136, the POS terminal 106 displays a tip confirmation. In some embodiments, the POS terminal 106 displays the tip confirmation in response to receiving a confirmation from one or more merchant services. For example, the POS terminal 106 may transmit credit card information received from the digital wallet device 104 and the tip amount to a credit card processing service. The credit card processing service may process the credit card information and transmit a payment confirmation to the POS terminal 106.

In some embodiments, the POS terminal 106 requests (e.g., via an API call) a batch authorization of the purchase amount and the tip amount to the payment processor based on the transaction code. In some embodiments, a batch authorization is not requested in response to a notification from the digital wallet device 104. For example, the digital wallet device 104 may identify a first tipping preference (e.g., no tip) based on the payment information received from the POS terminal 106. In response to determining that no tip will be paid, the digital wallet device 104 may send a notification to the POS terminal 106 indicating that no tip will be paid. In some embodiments, the digital wallet device 104 sends the notification indicating that no tip will be paid at step 124. The POS terminal 106 may transmit credit card information received from the digital wallet device 104 and the purchase amount to a credit card processing service in response to receiving the notification from the digital wallet device 104 at step 124. In some embodiments, a batch authorization request is not initiated if additional information is required. For example, the POS terminal 106 may require additional information from the digital wallet device 104 to complete one or more portions of the transaction. In such an example, the POS terminal 106 may complete the portions of the transaction (e.g., purchase) that do not require additional information and then later complete the rest of the transaction (e.g., tip) after receiving the additional information from the digital wallet device 104.

At step 138, the POS terminal 106 identifies receipt preferences associated with the user device 102. In some embodiments, the POS terminal 106 receives the receipt preferences when the POS terminal 106 receives the payment details at step 120 and/or when the POS terminal 106 receives the tipping preferences at step 134. In some embodiments, the user device 102 transmits receipt preferences to the POS terminal 106 using a near-field communication protocol. For example, a user may again tap the user device 102 on the POS terminal 106. In some embodiments, the user device 102 transmits receipt preferences to the POS terminal 106 using the Internet, a mobile phone network, a mobile voice or data network (e.g., a 4G, 5G, or LTE network), a cable network, a public switched telephone network, or other types of communications network or combinations of communications networks.

At step 140, the POS terminal 106 transmits a digital receipt to the digital wallet device 104. In some embodiments, the POS terminal 106 transmits the digital receipt based on one or more of receipt preferences identified at step 138. For example, a first preference may indicate a first receipt preference (e.g., digital receipt sent to the digital wallet device 104) for a first location type (e.g., restaurants). In some embodiments, the digital receipt comprises receipt data (e.g., item descriptions, prices, tax amounts, totals, etc.). In some embodiments, the POS terminal 106 transmits the digital receipt in a JavaScript Object Notation (JSON), Portable Document Format (PDF), Extensible Markup Language (XML) format, and/or similar such formats.

At step 142, the digital wallet device 104 transmits the digital receipt to the user device 102. In some embodiments, the digital wallet device 104 transmits the digital receipt based on one or more of preferences of the digital wallet profile associated with the user device 102. For example, a first preference may indicate a first receipt preference (e.g., digital receipt sent to the user device 102) for a first location type (e.g., restaurants).

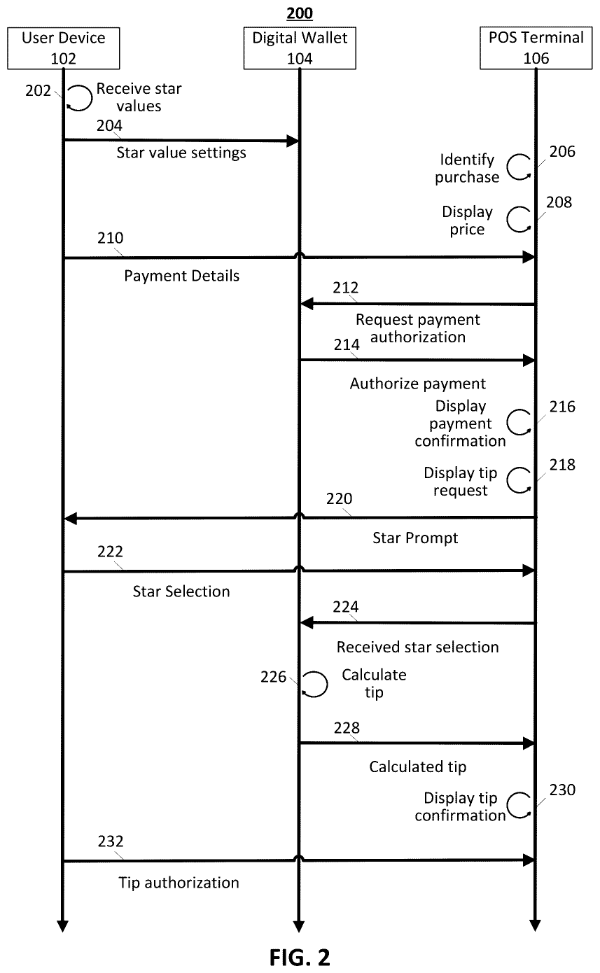

FIG. 2 shows an illustrative flowchart of a process 200 for providing a customizable digital wallet system that enables users to set their own preferences, in accordance with some embodiments of the disclosure. In some embodiments, some steps of process 200 may be performed by one of several devices. Although a user device 102, a digital wallet device 104, and a POS terminal 106 are shown, any number of servers and/or devices may be used. Further, different devices may perform different steps of the process 200 than what is shown. Although the process 200 is illustrated and described as a sequence of steps, it is contemplated that various embodiments of process 200 may be performed in any order or combination and need not include all the illustrated steps.

At step 202, the user device 102 receives star values. In some embodiments, the user device 102 receives the star values based on one or more user inputs. For example, the user device 102 may display a user interface (e.g., first user interface 306) comprising selectable options. A user may input tipping percentages and/or tipping amounts by selecting one or more of the options. For example, the user may input that one star corresponds to a 0% tip, two stars correspond to 5% tip, three stars correspond to 15%, and four starts correspond to 20%. Although stars are described, similar such media elements (e.g., icons, pictures, symbols, videos, graphics, animations, etc.) may be used. In some embodiments, different media elements correspond to different monetary values. For example, a smiley face may correspond to five dollars while a shooting star corresponds to twenty dollars. In some embodiments, the use of media elements alleviates social pressure and enhances privacy by not displaying the exact tip amount in real time. At step 204, the user device 102 transmits the star values to the digital wallet device 104.

At step 206, the POS terminal 106 identifies a purchase. In some embodiments, the process 200 uses the same or similar methods described at step 116 above. At step 208, the POS terminal 106 displays a price associated with the purchase. In some embodiments, the process 200 uses the same or similar methods described at step 118 above. At step 210, the user device 102 transmits payment details to the POS terminal 106. In some embodiments, the process 200 uses the same or similar methods described at step 120 above. At step 212, the POS terminal 106 transmits a payment authorization request to the digital wallet device 104. In some embodiments, the process 200 uses the same or similar methods described at step 122 above.

At step 214, the digital wallet device 104 transmits a payment authorization to the POS terminal 106. In some embodiments, the digital wallet device 104 identifies the digital wallet profile associated with the user device 102 based on the digital wallet profile identifier received from the POS terminal 106. In some embodiments, the digital wallet device 104 identifies the digital wallet profile associated with the user device 102 based on the payment information received from the POS terminal 106. The digital wallet device 104 may identify the digital wallet profile associated with the user device 102 based on a credit card number matching one or more credit card numbers associated with the digital wallet profile associated with the user device 102.

In some embodiments, the payment authorization comprises payment information (e.g., credit card information, transaction token, etc.) and a transaction code. The payment information may be based on one or more of the stored preferences. For example, the digital wallet profile associated with the user device 102 may have a first preference indicating a first payment method (e.g., first credit card) for a first location type (e.g., restaurants) and a second preference indicating a second payment method (e.g., second credit card) for a second location type (e.g., retail stores). In some embodiments, the transaction code is generated by the digital wallet device 104 and is associated with the purchase and/or the digital wallet profile. In some embodiments, the payment authorization comprises one or more preferences. For example, the payment authorization may comprise a preference indicating a customized tipping option. The customized tipping option may indicate that the user device 102 associated with the digital wallet profile prefers a discrete tipping option.

At step 216, the POS terminal 106 displays a payment confirmation. In some embodiments, the process 200 uses the same or similar methods described at step 126 above.

At step 218, the POS terminal 106 displays a tip request associated with the purchase. In some embodiments, the tip request is associated with one or more preferences received from the digital wallet device 104 at step 214. For example, the one or more preferences received from the digital wallet device 104 at step 214 may comprise a customized tipping option indicating that the user device 102 associated with the digital wallet profile prefers a discrete tipping option. The POS terminal 106 may display the tip request according to the discrete tipping option based on receiving the customized tipping option from the digital wallet device 104.

At step 220, the POS terminal 106 transmits a star prompt to the user device 102. In some embodiments, the star prompt is associated with one or more preferences received from the digital wallet device 104 at step 214. For example, the one or more preferences received from the digital wallet device 104 at step 214 may comprise a customized tipping option indicating that the user device 102 associated with the digital wallet profile prefers a discrete tipping option. The POS terminal 106 may transmit the star prompt based on receiving the customized tipping option from the digital wallet device 104. In some embodiments, the POS terminal 106 transmits the star prompt to the user device 102 using a near-field communication protocol. In some embodiments, the POS terminal 106 transmits the star prompt to the user device 102 using one or more communications networks.

At step 222, the user device 102 transmits a star selection to the POS terminal 106. In some embodiments, the star selection is based on one or more user inputs. For example, the user device 102 may display a user interface (e.g., second user interface 310) comprising selectable options. A user may input a star selection by selecting one or more of the options. For example, the user may input two stars. In another example, the user may select a shooting star graphic. In some embodiments, the user device 102 transmits the star selection to the POS terminal 106 using a near-field communication protocol. In some embodiments, the user device 102 transmits the star selection to the POS terminal 106 using one or more communications networks.

At step 224, the POS terminal 106 transmits the star selection received from the user device 102 to the digital wallet device 104. At step 226, the digital wallet device 104 calculates a tip amount using the received star selection. For example, if the received star selection is two stars, then the digital wallet device 104 determines a tipping percentage (e.g., 5%) that the digital wallet profile associates with the star selection (e.g., two stars). The digital wallet device 104 then calculate the tip amount (e.g., five dollars) using the tipping percentage (e.g., 5%) associated with the star selection (e.g., two stars) and the purchase price (100 dollars). At step 228, the digital wallet device 104 transmits the calculated tip to the POS terminal 106.

At step 230, the POS terminal 106 displays a tip confirmation. At step 232, the user device 102 transmits a tip authorization to the POS terminal 106. In some embodiments, the user device 102 transmits the tip authorization to the POS terminal 106 using a near-field communication protocol. For example, a user may tap the user device 102 on the POS terminal 106. In some embodiments, the user device 102 transmits the tip authorization to the POS terminal 106 using the Internet, a mobile phone network, a mobile voice or data network (e.g., a 4G, 5G, or LTE network), a cable network, a public switched telephone network, or other types of communications network or combinations of communications networks.

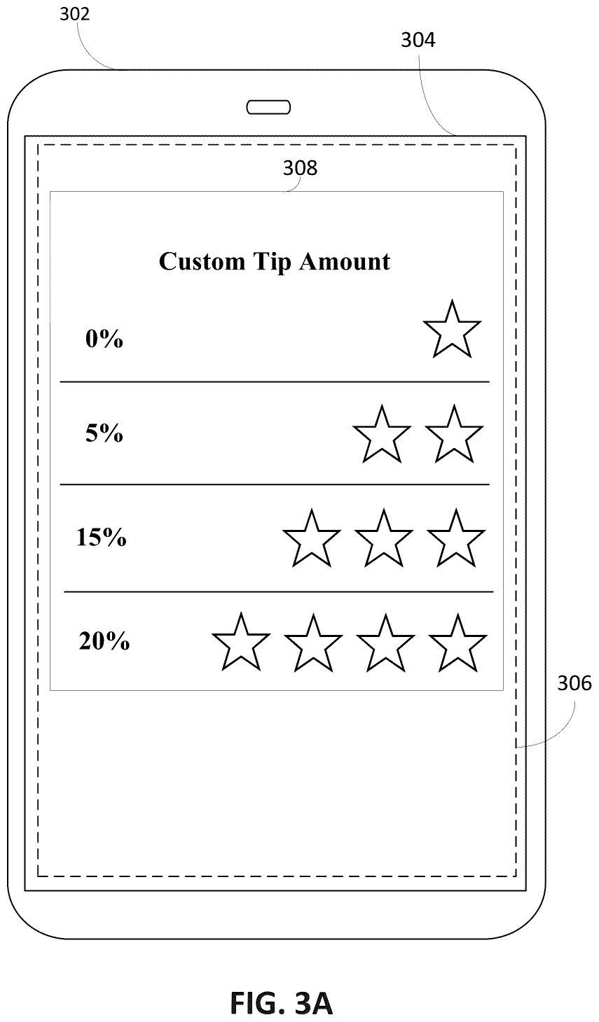

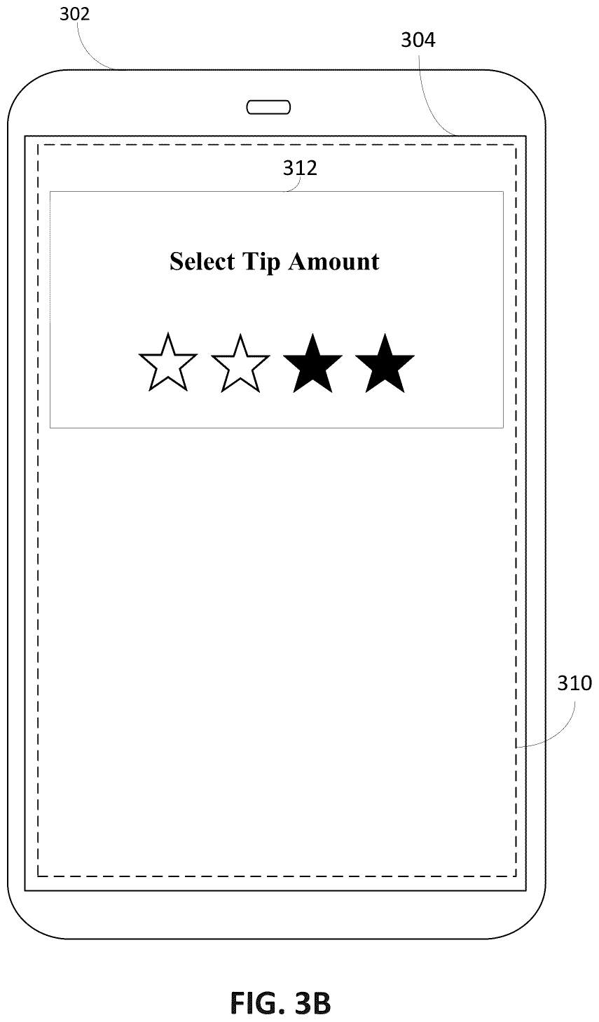

FIGS. 3A and 3B show illustrative diagrams of user interfaces associated with a digital wallet system, in accordance with some embodiments of this disclosure. The system includes a user device 302 with a display 304. The user device 302 may be a smartphone, a tablet, a laptop, a desktop computer, a smart watch or wearable device, smart glasses, a stereoscopic display, a wearable camera, AR glasses, an AR head-mounted display (HMD), a virtual reality (VR) HMD and/or any other device suitable for media display. FIG. 3A shows the display 304 displaying a first user interface 306. In some embodiments, the first user interface 306 comprises a custom tipping graphic 308 comprising a plurality of selectable options. For example, the user may input that one star corresponds to a 0% tip, two stars correspond to a 5% tip, three stars correspond to a 15% tip, and four starts correspond to a 20% tip. Although stars are described, similar such media elements (e.g., icons, pictures, symbols, videos, graphics, animations, etc.) may be used. In some embodiments, different media elements correspond to different monetary values. For example, a smiley face may correspond to five dollars while a shooting star corresponds to twenty dollars.

FIG. 3B shows the display 304 displaying a second user interface 310. In some embodiments, the second user interface 310 comprises a tipping option 312. In some embodiments, the tipping option 312 is displayed in response to the user device 302 receiving a star prompt (e.g., step 220 of FIG. 2). In some embodiments, a user may select one or more stars and each star corresponds to a tipping percentage. In some embodiments, the selection of stars corresponds to custom tipping graphic 308 of FIG. 3A. For example, if the user selects two stars, then the user device 302 may transmit a tipping percentage of 5%. In some embodiments, the use of media elements (e.g., stars) alleviates social pressure and enhances privacy by not displaying the exact tip amount in real time.

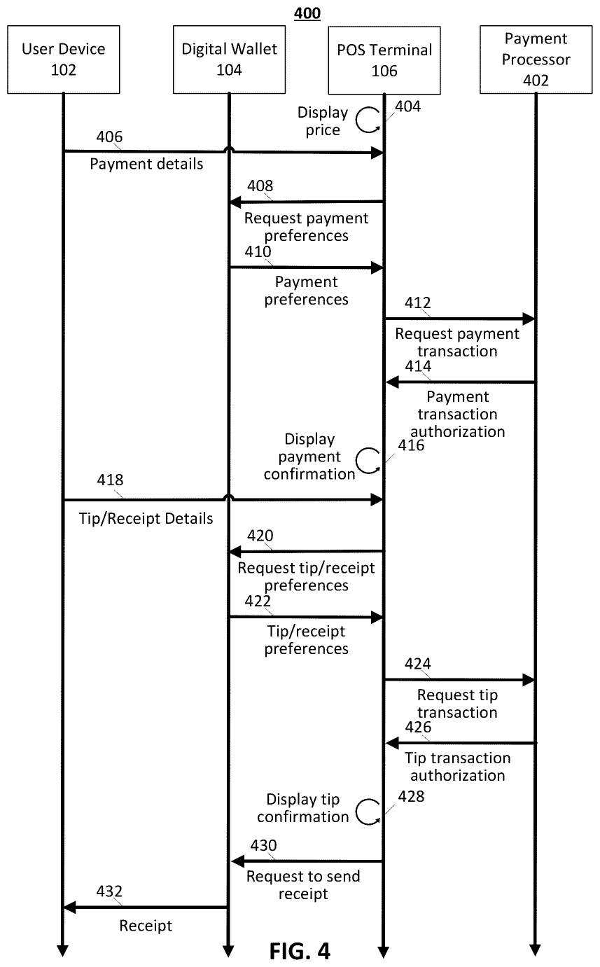

FIG. 4 shows an illustrative flowchart of a process 400 for providing a customizable digital wallet system that enables users to set their own preferences, in accordance with some embodiments of the disclosure. In some embodiments, some steps of process 400 may be performed by one of several devices. Although a user device 102, a digital wallet device 104, a POS terminal 106, and a payment processor 402 are shown, any number of servers and/or devices may be used. Further, different devices may perform different steps of the process 400 than what is shown. Although the process 400 is illustrated and described as a sequence of steps, it is contemplated that various embodiments of process 400 may be performed in any order or combination and need not include all the illustrated steps.

At step 404, the POS terminal 106 displays a price associated with a purchase. In some embodiments, the POS terminal also displays a request for payment. At step 406, the user device 102 transmits payment details. In some embodiments, the process 400 uses the same or similar methods described at step 120 above. At step 408, the POS terminal 106 transmits a payment preference request to the digital wallet device 104. In some embodiments, the payment preference request comprises a digital wallet profile identifier and/or the payment information (e.g., credit card information, transaction token, etc.) received from the user device 102 at step 406.

At step 410, the digital wallet device 104 transmits payment preferences to the POS terminal 106. In some embodiments, the digital wallet device 104 identifies the payment preferences based on the digital wallet profile identifier received from the POS terminal 106. In some embodiments, the digital wallet device 104 identifies the digital wallet profile based on the payment information received from the POS terminal 106. For example, the POS terminal 106 may transmit a first credit card number and the digital wallet device 104 may compare the first credit card number to a plurality of credit card numbers associated with a plurality of digital wallet profiles. The digital wallet device 104 may identify the digital wallet profile based on the first credit card number matching one or more credit card numbers associated with the digital wallet profile.

In some embodiments, the payment preferences comprise payment information (e.g., credit card information, transaction token, etc.) and a transaction code. The payment preferences may comprise one or more of the digital wallet profile preferences. For example, the digital wallet profile may have a first preference indicating a first payment method (e.g., first credit card) for a first location type (e.g., restaurants) and a second preference indicating a second payment method (e.g., second credit card) for a second location type (e.g., retail stores). In some embodiments, the transaction code is generated by the digital wallet device 104 and is associated with the purchase and/or the digital wallet profile.

At step 412, the POS terminal 106 transmits a payment transaction request to the payment processor 402. In some embodiments, the payment transaction request comprises credit card information received from the digital wallet device 104 at step 410 and a purchase amount. At step 414, the payment processor 402 transmits a payment transaction authorization to the POS terminal 106. In some embodiments, the payment transaction authorization indicates that the payment processor 402 successfully completed the transaction for the purchase amount using the credit card information received from the POS terminal 106 at step 412. At step 416, the POS terminal 106 displays payment confirmation.

At step 418, the user device 102 transmits tip/receipt details to the POS terminal 106. In some embodiments, the user device 102 transmits tip/receipt details to the POS terminal 106 using a near-field communication protocol. In some embodiments, the user device 102 transmits the tip/receipt details to the POS terminal 106 using one or more communications networks. In some embodiments, the tip/receipt details comprise the digital wallet profile identifier and/or payment information. At step 420, the POS terminal 106 transmits a tip/receipt preference request to the digital wallet device 104. In some embodiments, the tip/receipt preference request comprises the digital wallet profile identifier and/or the payment information (e.g., credit card information, transaction token, etc.) received from the user device 102. In some embodiments, the tip/receipt request also comprises the transaction code.

At step 422, the digital wallet device 104 transmits the tip/receipt preferences to the POS terminal 106. In some embodiments, the digital wallet device 104 identifies tipping preferences and/or receipt preference associated with the digital wallet profile based on the digital wallet profile identifier received from the POS terminal 106 at step 420. In some embodiments, the digital wallet device 104 identifies tipping preferences and/or receipt preference associated with the digital wallet profile based on the transaction code received from the POS terminal 106. In some embodiments, the digital wallet device 104 identifies tipping preferences and/or receipt preference associated with the digital wallet profile based on the payment information received from the POS terminal 106. After identifying the digital wallet profile, the digital wallet device 104 may then identify the tipping preferences and/or receipt preferences associated with the digital wallet profile.

In some embodiments, the tipping preferences comprise a tipping amount. The digital wallet device 104 may calculate a tipping amount using one or more tipping preferences. For example, the digital wallet profile may comprise a first preference indicating a first tipping percentage (e.g., 25%) for a first location type (e.g., sit-down restaurant). The purchase may correspond to a 100$ meal and the digital wallet device 104 may calculate (e.g., based on the first tipping preference) that the tipping amount should be 25$. In some embodiments, the digital wallet device 104 transmits the tipping amount (e.g., 25$) to the POS terminal 106.

In some embodiments, the tipping preferences comprise additional payment information (e.g., credit card information, transaction token, etc.), a tip amount, and a transaction code. In some embodiments, the additional payment information corresponds to a payment method for the tip amount. For example, the additional payment information may indicate that the same credit card that was used to pay for the purchase amount should be used to pay for the tip amount. In some embodiments, the additional payment information is based on one or more of the preferences associated with the digital wallet profile. For example, the digital wallet profile may have a first preference indicating a first payment method (e.g., first credit card) for a first transaction type (e.g., purchases) and a second preference indicating a second payment method (e.g., second credit card) for a second transaction type (e.g., tips).

In some embodiments, the digital wallet device 104 and/or the POS terminal 106 links the initial purchase and the tip. For example, the digital wallet device 104 and/or the POS terminal 106 may link the initial purchase and the tip using the payment information (e.g., credit card number(s), credit card expiration date(s), credit card CVV code(s), and/or similar such information) received at steps 406, 410, and/or 422, along with the transaction code. In another example, the digital wallet device 104 and/or the POS terminal 106 may link the initial purchase and the tip using the transaction token (e.g., DAN) and the transaction code. In some embodiments, linking the initial purchase and the tip ensures that additional payments (e.g., tips) are correctly attributed to the same vendor as the initial payment, maintaining transaction integrity. In some embodiments, the tipping preferences may be altered at any time by the user. For example, a user may access their digital wallet profile using the user device 102 and alter the tip amount associated with the purchase. In some embodiments, the user is only able to alter their tip amount within a specified time period (e.g., before the end of day).

At step 424, the POS terminal 106 transmits a tip transaction request to the payment processor 402. In some embodiments, the tip transaction request comprises credit card information received from the digital wallet device 104 at step 422 and a tip amount. In some embodiments, the POS terminal 106 requests (e.g., via an API call) a batch authorization of the purchase amount and the tip amount to the payment processor 402 based on the purchase being linked to the tip amount. For example, step 414 and step 424 may be consolidated into a single step. This may be helpful in cases where the vendor or business associated with the POS terminal 106 has restrictions on the minimum amount for credit card transactions. At step 426, the payment processor 402 transmits a tip transaction authorization to the POS terminal 106. In some embodiments, the tip transaction authorization indicates that the payment processor 402 successfully completed the transaction for the tip amount using the credit card information received from the POS terminal 106 at step 424. At step 428, the POS terminal 106 displays a tip confirmation.

At step 430, the POS terminal 106 transmits a request to send receipt. In some embodiments, the POS terminal 106 transmits the request to send receipt based on one or more receipt preferences received at step 422. For example, a first preference may indicate a first receipt preference (e.g., receipt sent to the digital wallet device 104) for a first location type (e.g., restaurants). In some embodiments, the request to send receipt comprises receipt data (e.g., item descriptions, prices, tax amounts, totals, etc.).

At step 432, the digital wallet device 104 transmits the receipt to the user device 102. In some embodiments, the digital wallet device 104 transmits the receipt based on one or more of receipt preferences associated with the digital wallet profile. In some embodiments, the digital receipt comprises receipt data (e.g., item descriptions, prices, tax amounts, totals, etc.). In some embodiments, the digital wallet device 104 translates the receipt data received from the POS terminal 106 into JSON, PDF, XML, and/or similar such formats before storing and/or transmitting the receipt. In some embodiments, the digital wallet device 104 translates the receipt data received from the POS terminal 106 based on one or more of receipt preferences associated with the digital wallet profile. For example, a first preference may indicate a first receipt format (e.g., XML) for a first location type (e.g., restaurants).

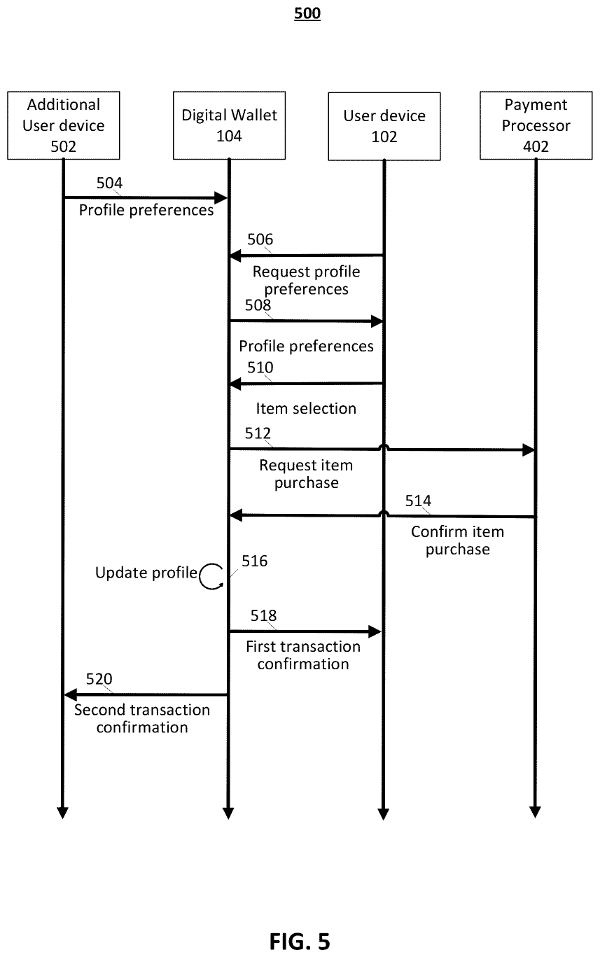

FIG. 5 shows an illustrative flowchart of a process 500 for providing a customizable digital wallet system that enables users to set their own preferences, in accordance with some embodiments of the disclosure. In some embodiments, some steps of process 500 may be performed by one of several devices. Although a user device 102, an additional user device 502, a digital wallet device 104, and a payment processor 402 are shown, any number of servers and/or devices may be used. Further, different devices may perform different steps of the process 500 than what is shown. Although the process 500 is illustrated and described as a sequence of steps, it is contemplated that various embodiments of process 500 may be performed in any order or combination and need not include all the illustrated steps.

At step 504, the additional user device 502 transmits profile preferences to the digital wallet device 104. In some embodiments, the user device 102 receives the profile preferences based on a user creating and/or updating a digital wallet profile. For example, a service personnel (e.g., waiter) may create a digital wallet profile associated with the service personnel. The service personnel's digital wallet profile may comprise preferences such as tipping preference. For example, the service personnel's digital wallet profile may have a first preference indicating a preference for tips in the form of virtual items (e.g., e-books, music tracks, application codes, or virtual currency) instead of money gratuities.

At step 506, the user device 102 transmits a profile preference request to the digital wallet device 104. In some embodiments, the user device 102 transmits the profile preference request in response to a transaction event. For example, a user may wish to tip the service personnel (e.g., waiter) associated with a purchase (e.g., dinner) according to the service personnel's tipping preferences. Accordingly, the user may access the digital wallet profile associated with the service personnel to determine the service personnel's tipping preferences. In some embodiments, a POS terminal associated with the transaction event transmits a digital profile identifier corresponding to the service personnel's digital wallet profile to the user device 102 using one or more communication networks (e.g., NFC, Bluetooth, LTE network, etc.). For example, the user may tap the user device 102 on the POS terminal and the POS terminal transmits the digital profile identifier corresponding to the service personnel's digital wallet profile to the user device 102 using an NFC protocol. In some embodiments, the additional user device 502 transmits the digital profile identifier corresponding to the service personnel's digital wallet profile to the user device 102 using one or more communication networks (e.g., NFC, Bluetooth, LTE network, etc.). In some embodiments, the user device 102 scans a QR code and/or inputs a code corresponding to the service personnel's digital wallet profile.

At step 508, the digital wallet device 104 transmits the profile preferences to the user device 102. In some embodiments, the profile preference comprise the preferences described at step 506.

At step 510, the user device 102 transmits an item selection to the digital wallet device 104. In some embodiments, the item selection corresponds to one or more items identified in the profile preferences received at step 508. For example, the user device 102 may display one or more virtual items (e.g., e-books, music tracks, application codes, or virtual currency) identified by the service personnel's digital wallet profile. A user may select a first item (e.g., e-book) as a tip associated with the purchase (e.g., dinner).

At step 512, the digital wallet device 104 transmits an item purchase request to the payment processor 402. In some embodiments, the item purchase request comprises payment information and an item identifier, wherein the item identifier corresponds to the item selected at step 510. At step 514, the payment processor 402 transmits an item purchase confirmation to the digital wallet 104. In some embodiments, the item purchase confirmation indicates that the payment information was processed, and the item was successfully purchased.

At step 516, the digital wallet device 104 updates the profile. In some embodiments, the digital wallet device 104 updates the service personnel's digital wallet profile by updating one or more preferences associated with the service personnel's digital wallet profile. For example, the digital wallet device 104 may change a preference indicating a preference for tips in the form of a first item (e.g., an e-book) to an updated preference indicating a preference for tips in the form of a second item (e.g., a music track) because the first item has already been purchased for the service personnel.

At step 518, the digital wallet device 104 transmits a first transaction confirmation to the user device 102. In some embodiments, the first transaction confirmation indicates that the item selected in step 510 was successfully purchased and/or transferred to the service personnel's digital wallet profile. At step 520, the digital wallet device 104 transmits a second transaction confirmation to the additional user device 502. In some embodiments, the second transaction confirmation also indicates that the item selected in step 510 was successfully purchased and/or transferred to the service personnel's digital wallet profile.

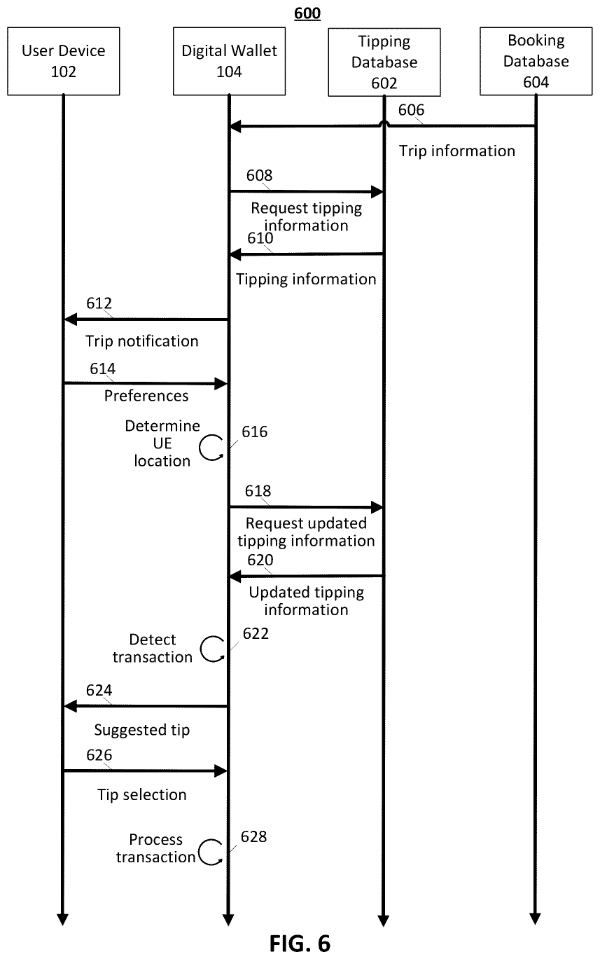

FIG. 6 shows an illustrative flowchart of a process 600 for providing a customizable digital wallet system that enables users to set their own preferences, in accordance with some embodiments of the disclosure. In some embodiments, some steps of process 600 may be performed by one of several devices. Although a user device 102, a digital wallet device 104, a tipping database 602, and a booking database 604 are shown, any number of servers, databases, and/or devices may be used. Further, different devices may perform different steps of the process 600 than what is shown. Although the process 600 is illustrated and described as a sequence of steps, it is contemplated that various embodiments of process 600 may be performed in any order or combination and need not include all the illustrated steps.

At step 606, the booking database 604 transmits trip information to the digital wallet device 104. In some embodiments, the trip information comprises trip data (e.g., locations, dates, etc.) and a digital wallet identifier. In some embodiments, the booking database 604 comprises a plurality of trip information corresponding to a plurality of trips. In some embodiments, the booking database 604 comprises a plurality of calendars associated with a plurality of users. For example, the booking database 604 may have access to a calendar associated with the user corresponding to the digital wallet identifier. In some embodiments, the booking database 604 is part of a corporate booking database and stores trip information corresponding to upcoming business trips. In some embodiments, the booking database 604 transmits trip information to the digital wallet device 104 in response to a user booking a trip. In some embodiments, the booking database 604 transmits trip information to the digital wallet device 104 in response to an approaching trip (e.g., a trip is within a threshold (e.g., five days, one month, etc.) time frame).

At step 608, the digital wallet device 104 transmits a tipping information request to the tipping database 602. In some embodiments, the digital wallet device 104 transmits the tipping information request to the tipping database 602 in response to receiving the trip information at step 606. In some embodiments, the digital wallet device 104 transmits the tipping information request to the tipping database 602 in response to an approaching trip (e.g., a trip is within a threshold (e.g., five days, one month, etc.) time frame). In some embodiments, the tipping information request comprises one or more pieces of trip data. For example, the tipping information request may comprise a first location (e.g., Japan) and a second location (e.g., France).

At step 610, the tipping database 602 transmits tipping information to the digital wallet device 104. In some embodiments, the tipping information comprises tipping customs related to the one or more locations associated with the trip information request. For example, the tipping information may indicate a first tipping custom (e.g., no tip) for a first location (e.g., Japan) and may indicate as second tipping custom (e.g., 10%) for a second location (e.g., France).

At step 612, the digital wallet device 104 transmits a trip notification to the user device 102. In some embodiments, the trip notification comprises trip data and/or tipping information (e.g., tipping customs) related to the upcoming trip. In some embodiments, the digital wallet device 104 transmits the trip notification to the user device 102 in response to an approaching trip (e.g., a trip is within a threshold (e.g., five days, one month, etc.) time frame).

At step 614, the user device 102 transmits preferences to the digital wallet device 104. In some embodiments, the preferences comprise tipping preferences based on location, location type, payment method, transaction type, receipt preference, and/or similar such information as described herein.

At step 616, the digital wallet device 104 determines the location of the user device 102. In some embodiments, the digital wallet device 104 determines the location of the user device 102 based on location information received from the user device 102. For example, the user device 102 may access the digital wallet device 104 using an IP address associated with a first location (e.g., France) and the digital wallet device 104 determines that the user device 102 is located in the first location (e.g., France). In another example, the user device 102 transmits a location update message when the user device 102 changes from a first location (e.g., United States) to a second location (e.g., France). In some embodiments, the digital wallet device 104 determines the location of the user device 102 based on the trip information received at step 606. For example, the trip information may indicate a first-time frame (e.g., between Jan. 1, 2025 and Jan. 10, 2025) where the user device 102 will be located in a first location (e.g., Japan). The digital wallet device 104 may determine that the user device 102 is located in the first location (e.g., Japan) based on the date (e.g., Jan. 1, 2025) and the first-time frame (e.g., between Jan. 1, 2025 and Jan. 10, 2025).

At step 618, the digital wallet device 104 transmits an updated tipping information request to the tipping database 602. In some embodiments, the digital wallet device 104 transmits the updated tipping information request to the tipping database 602 in response to determining the location of user device 102 at step 616. For example, the digital wallet device 104 may transmit an update tipping information request indicating a first location (e.g., Japan) in response to detecting the user device 102 in the first location (e.g., Japan). In some embodiments, the digital wallet device 104 transmits the updated tipping information request to the tipping database 602 in response to an approaching trip (e.g., a trip is within a threshold (e.g., five days, one month, etc.) time frame). In some embodiments, the tipping information request comprises one or more pieces of trip data. At step 620, the tipping database 602 transmits updated tipping information to the digital wallet device 104. In some embodiments, the updated tipping information comprises tipping customs related to the one or more locations associated with the trip information request.

At step 622, the digital wallet device 104 detects a transaction. In some embodiments, the digital wallet 104 detects the transaction in response to receiving a notification from a POS terminal (e.g., POS terminal 106). For example, the POS terminal may transmit a payment authorization request to the digital wallet device 104. In another example, the POS terminal may transmit a tipping preference request to the digital wallet device 104. In some embodiments, the digital wallet device 104 detects the transaction in response to receiving a notification from the user device 102. For example, the user device 102 may transmit a transaction notification to the digital wallet device 104 in response to a user input and/or in response to the user device 102 detecting a transaction.

At step 624, the digital wallet device 104 transmits a suggested tip to the user device 102. In some embodiments, the suggested tip is based on the tipping information received from the tipping database, the location of the user device 102 determined at step 616, transaction information associated with transaction detected at step 622, and/or the preferences received at step 614. For example, the digital wallet device 104 may determine a suggested tip (e.g., no tip) based on the location (e.g., Japan) of the user device 102 and the tipping information (e.g., tipping customs of Japan) received from the tipping database. In another example, the digital wallet device 104 may determine a suggested tip (e.g., 10%) based on transaction information (e.g., transaction occurs in France) and the tipping information (e.g., tipping customs of France) received from the tipping database.

At step 626, the user device 102 transmits a tip selection to the digital wallet device 104. In some embodiments, the user device 102 receives the tip selection based on one or more user inputs. For example, the user device 102 may comprise a user interface comprising selectable options. A user may input a tip selection (e.g., 10%) by selecting one or more of the options. At step 628, the digital wallet device 104 processes the transaction. For example, the digital wallet device may transmit the tip selection, payment information, and/or a transaction code to a POS terminal 106. In some embodiments, the digital wallet device 104 calculates the tip amount according to the tip selection and uses the calculated tip to process the transaction.

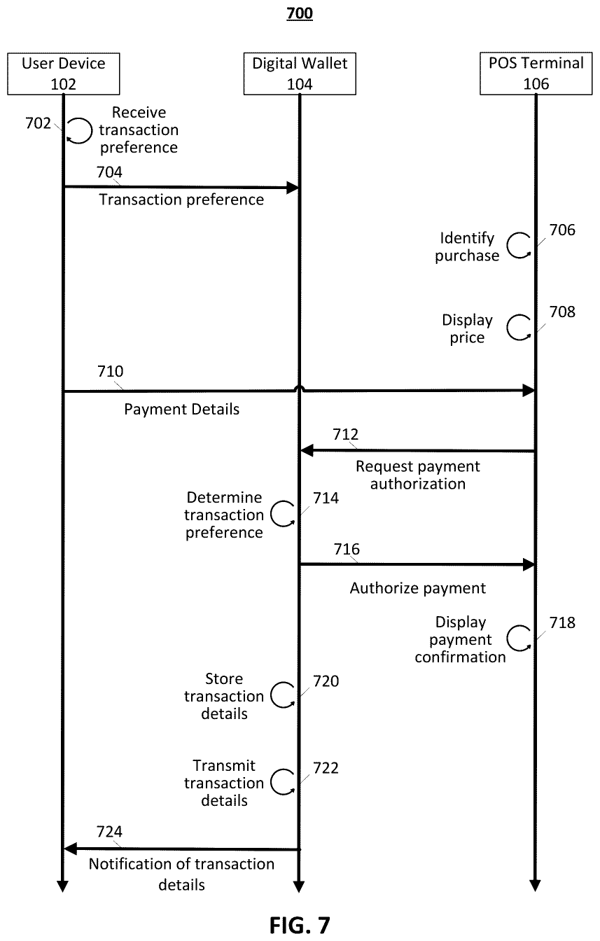

FIG. 7 shows an illustrative flowchart of a process 700 for providing a customizable digital wallet system that enables users to set their own preferences, in accordance with some embodiments of the disclosure. In some embodiments, some steps of process 700 may be performed by one of several devices. Although a user device 102, a digital wallet device 104, and a POS terminal 106 are shown, any number of servers and/or devices may be used. Further, different devices may perform different steps of the process 700 than what is shown. Although the process 700 is illustrated and described as a sequence of steps, it is contemplated that various embodiments of process 700 may be performed in any order or combination and need not include all the illustrated steps.

At step 702, the user device 102 receives a transaction preference. In some embodiments, the transaction preference corresponds to different transaction types (e.g., business, personal, etc.). For example, a first preference may indicate a first payment method (e.g., first credit card) for a first transaction type (e.g., business transaction) and a second preference may indicate a second payment method (e.g., second credit card) for a second transaction type (e.g., personal transaction). In another example, a first preference may indicate a first preference (e.g., digital receipt sent to a business email address) for a first transaction type (e.g., business transaction) and a second preference may indicate a second preference (e.g., digital receipt sent to a personal email address) for a second transaction type (e.g., personal transaction).

In some embodiments, the transaction preference comprises transaction characteristics (e.g., location, time, purchase-type, etc.) related a transaction type. For example, the user may associate a first transaction type (e.g., business transaction) with a first-time frame (e.g., between Jan. 1, 2025 and Jan. 10, 2025), a first location (e.g., Japan), and/or a first purchase-type (e.g., meals, transportation, etc.). At step 704, the user device 102 transmits the transaction preference to the digital wallet device 104.

At step 706, the POS terminal 106 identifies a purchase. In some embodiments, the process 700 uses the same or similar methods described at step 116 above. At step 708, the POS terminal 106 displays a price related to the purchase. In some embodiments, the process 700 uses the same or similar methods described at step 118 above.

At step 710, the user device 102 transmits payment details to the POS terminal 106. In some embodiments, the process 700 uses the same or similar methods described at step 120 above. In some embodiments, the payment details comprise a business transaction indicator. For example, before the user taps the user device 102 on the POS terminal 106, the user may select a business transaction option displayed on the user device 102. In response to the user selecting the business transaction option, the user device 102 may transmit payment details comprising a business transaction indicator to the POS terminal 106 at step 710.

At step 712, the POS terminal 106 transmits a payment authorization request to the digital wallet device 104. In some embodiments, the payment authorization request comprises a digital wallet profile identifier, payment information (e.g., credit card information, transaction token, etc.), and/or a business transaction indicator received from the user device 102 at step 710. In some embodiments, the payment authorization request also comprises payment details (e.g., location related to the payment, time of the payment, goods/services associated with the payment, etc.) related to the payment of the payment authorization request.

At step 714, the digital wallet device 104 determines a transaction preference. In some embodiments, the digital wallet device 104 determines the transaction preference by first determining a digital wallet profile associated with the payment. In some embodiments, the digital wallet device 104 determines the digital wallet profile associated with the payment using any of the methodologies described above.

In some embodiments, the digital wallet device 104 determines the transaction preference by determining a transaction type associated with the payment then identifies the transaction preferences associated with the transaction type. For example, the digital wallet device 104 may compare one or more payment details (e.g., location) related to the payment with one or more transaction details (e.g., location associated with a business transaction). If the one or more payment details (e.g., location) match the one or more transaction details (e.g., location associated with a business transaction) then the digital wallet device 104 may determine that the payment corresponds to a first transaction type (e.g., business transaction). In response to determining the transaction type (e.g., business transaction) associated with the payment, the digital wallet device 104 then identifies the transaction preferences (e.g., payment method) associated with the transaction type (e.g., business transaction). In some embodiments, the digital wallet device 104 determines the transaction type of the payment based on the business transaction indicator received at step 712.

At step 716, the user device 102 transmits a payment authorization to the POS terminal 106. In some embodiments, the payment authorization comprises payment information (e.g., credit card information, transaction token, etc.) and a transaction code. The payment information may be based on one or more of the stored preferences associated with a transaction type. At step 718, POS terminal 106 displays a payment confirmation. In some embodiments, the process 700 uses the same or similar methods described at step 126 above.

At step 720, the digital wallet device 104 stores transaction details. In some embodiments the digital wallet device 104 stores transaction details (e.g., location, amount, time, etc.) related to the payment. In some embodiments the digital wallet device 104 associates the transaction with a trip identifier.

At step 722, the digital wallet device 104 transmits transaction details. In some embodiments the digital wallet device 104 transmits the transaction details according to one or more transaction preferences received at step 704. For example, a first preference may indicate to send transaction details (e.g., location, amount, time, etc.) related to the payment of a first transaction type (e.g., business transaction) to a first email address (e.g., business expense report email address). At step 724, the digital wallet device 104 transmits a notification of the transaction details to the user device 102.

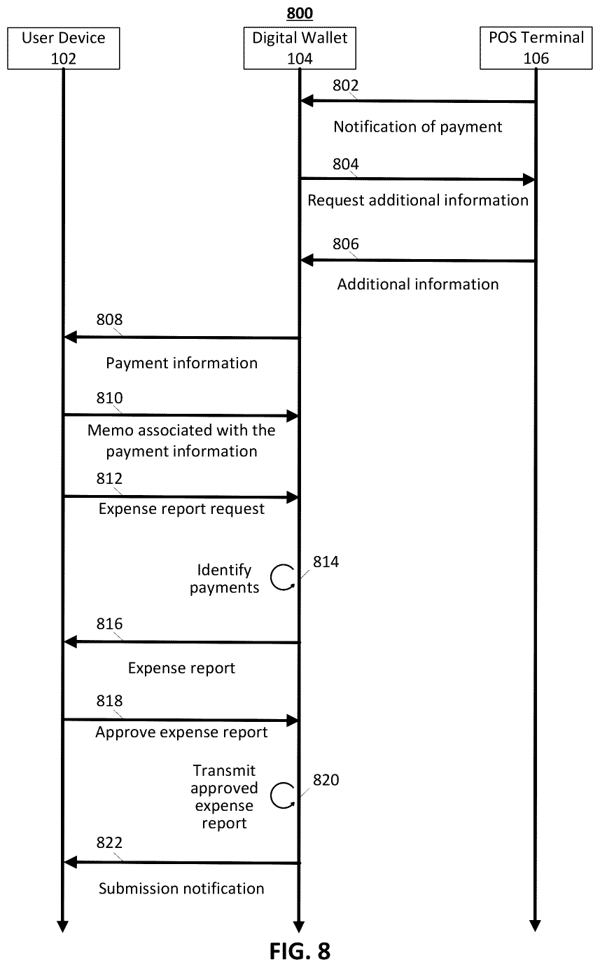

FIG. 8 shows an illustrative flowchart of a process 800 for providing a customizable digital wallet system that enables users to set their own preferences, in accordance with some embodiments of the disclosure. In some embodiments, some steps of process 800 may be performed by one of several devices. Although a user device 102, a digital wallet device 104, and a POS terminal 106 are shown, any number of servers and/or devices may be used. Further, different devices may perform different steps of the process 800 than what is shown. Although the process 800 is illustrated and described as a sequence of steps, it is contemplated that various embodiments of process 800 may be performed in any order or combination and need not include all the illustrated steps.

At step 802, the POS terminal 106 transmits a payment notification to the digital wallet device 104. In some embodiments, the payment notification comprises a digital wallet profile identifier and/or payment information (e.g., credit card information, transaction token, etc.). In some embodiments, the POS terminal 106 transmits the payment notification in response to receiving payment details from the user device 102. In some embodiments, the payment notification also comprises payment details (e.g., location related to the payment, time of the payment, goods/services associated with the payment, etc.) related to the payment.

At step 804, the digital wallet device 104 transmits an additional information request to the POS terminal 106. In some embodiments, the digital wallet device 104 transmits the additional information request in response to determining that the payment is of a certain transaction type. In some embodiments, the digital wallet device 104 determines the transaction type by first determining a digital wallet profile associated with the transaction. In some embodiments, the digital wallet device 104 determines the digital wallet profile associated with the payment using any of the methodologies described above.

In some embodiments, the digital wallet device 104 determines the transaction type of the payment using payment details (e.g., location related to the payment, time of the payment, goods/services associated with the payment, etc.) received at step 802. If the one or more payment details (e.g., location) match one or more transaction details (e.g., location associated with a business transaction) then the digital wallet device 104 may determine that the payment corresponds to a first transaction type (e.g., business transaction).

In some embodiments, the digital wallet device 104 transmits the additional information request for certain vendor types (e.g., mobile applications) and/or for certain transaction types (e.g., business transactions). For example, when the POS terminal 106 is associated with a vendor (e.g., Uber) of a first vendor type (e.g., mobile application vendor) then the digital wallet device 104 transmits the additional information request to the POS terminal 106. In some embodiments, the additional information request requests detailed information (e.g., route, fare breakdown, digital receipt, etc.) from the POS terminal 106. At step 806, the POS terminal 106 transmits additional information to the digital wallet device 104. In some embodiments, the additional information corresponds to the additional information requested in the additional information request.

At step 808, the digital wallet device 104 transmits payment information to the user device 102. In some embodiments, the payment information provides the additional information received at step 806. For example, the payment information may comprise the payment amount, vendor name (e.g., Uber), route, fare breakdown, digital receipt, and/or similar such information. In some embodiments, the additional information comprises a transaction type indicator. For example, the payment information may comprise a first transaction type indicator (e.g., business transaction) associated with the payment amount (e.g., price of the Uber trip).

At step 810, the user device 102 transmits a memo associated with the payment information to the digital wallet device 104. In some embodiments, the memo comprises edits and/or additions to the payment information. For example, the memo may be a summary related to the payment amount. In some embodiments, the memo may comprise one or more portions that are posted on one or more review sites (e.g., Yelp) as comments related to a verified transaction. In some embodiments, steps 802 through 810 may be repeated for a plurality of payments. In some embodiments, the digital wallet device 104 categorizes one or more payments of the plurality of payments. For example, the digital wallet device 104 may identify a first plurality of payments as relating to a first trip identifier.

At step 812, the user device 102 transmits an expense report request to the digital wallet device 104. In some embodiments, the expense report request comprises one or more trip identifiers and/or transaction types. For example, the expense report request may request the generation of an expense report of all payments related to a first transaction type (e.g., business transaction). In another example, the expense report request may request the generation of an expense of all payments related to a first trip identifier.

At step 814, the digital wallet device 104 identifies one or more payments. In some embodiments, the digital wallet device 104 identifies one or more payments requested by the expense report request. For example, the expense report request may request the generation of an expense report of all payments related to a first trip identifier and the digital wallet device 104 identifies all payments related to the first trip identifier. In some embodiments, the digital wallet device 104 also identifies payment information and/or memos associated with the one or more payments requested by the expense report request.

At step 816, the digital wallet device 104 transmits the expense report to the user device 102. In some embodiments, the expense report comprises the one or more payments identified at step 814. In some embodiments, the expense report also comprises payment information (e.g., payment information of step 808) associated with the one or more payments identified at step 814. In some embodiments, the expense report also comprises one or more memos (e.g., memos of step 810) associated with the one or more payments identified at step 814.

At step 818, the user device 102 transmits an expense report approval to the digital wallet device 104. In some embodiments, the user of the user device 102 can add, remove, and/or edit payments included in the expense report received at step 816. In some embodiments, the user device 102 transmits the expense report approval in response to a user selecting an option approving the expense report.

At step 820, the digital wallet device 104 transmits the approved expense report. In some embodiments, the digital wallet device 104 translates the approved expense report into JSON, PDF, XML, and/or similar such formats before transmitting the receipt. In some embodiments, the digital wallet device 104 translates the approved expense report based on one or more expense report preferences associated with the digital wallet profile. At step 822, the digital wallet device 104 transmits an expense report submission notification to the user device 102. In some embodiments, the digital wallet device 104 transmits the expense report submission notification to the user device 102 after submitting the expense report to one or more devices.

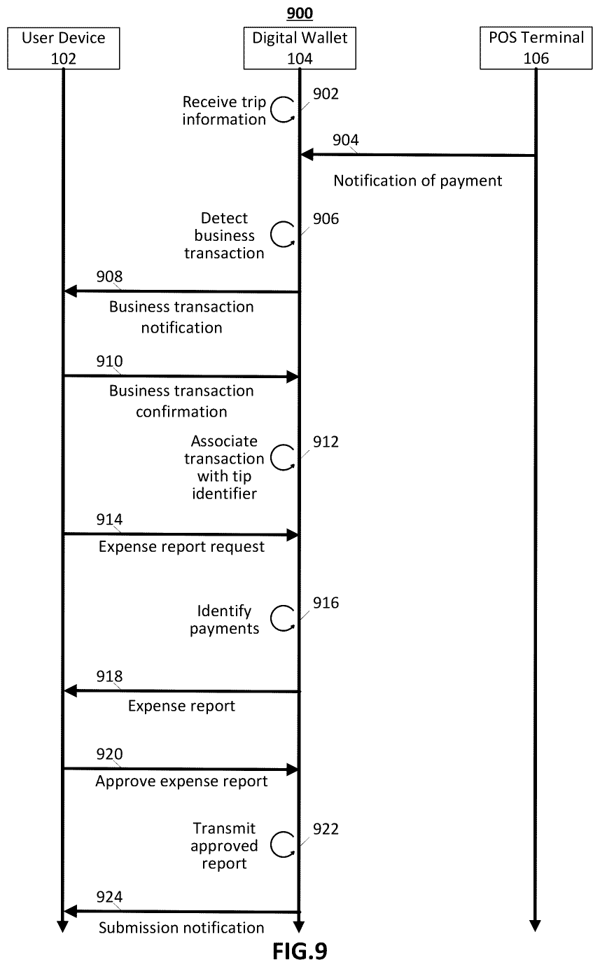

FIG. 9 shows an illustrative flowchart of a process 900 for providing a customizable digital wallet system that enables users to set their own preferences, in accordance with some embodiments of the disclosure. In some embodiments, some steps of process 900 may be performed by one of several devices. Although a user device 102, a digital wallet device 104, and a POS terminal 106 are shown, any number of servers and/or devices may be used. Further, different devices may perform different steps of the process 900 than what is shown. Although the process 900 is illustrated and described as a sequence of steps, it is contemplated that various embodiments of process 900 may be performed in any order or combination and need not include all the illustrated steps.

At step 902, the digital wallet device 104 receives trip information. In some embodiments, the digital wallet device 104 receives the trip information from one or more user device (e.g., user device 102) and/or one or more databases (e.g., booking database, calendar database, etc.). In some embodiments, the trip information comprises trip data (e.g., locations, dates, etc.) and a digital wallet identifier. In some embodiments, the digital wallet device 104 receives trip information in response to a user booking a trip. In some embodiments, the digital wallet device 104 receives trip information in response to an approaching trip (e.g., a trip is within a threshold (e.g., five days, one month, etc.) time frame). In some embodiments, the trip information comprises a trip identifier.

At step 904, the POS terminal 106 transmits a payment notification to the digital wallet device 104. In some embodiments, the process 900 uses the same or similar methods described at step 802 above.

At step 906, the digital wallet device 104 detects a business transaction related to the payment notification. In some embodiments, the digital wallet device 104 may compare one or more payment details (e.g., location, date, etc.) related to the payment notification of step 904 with one or more pieces of trip data (e.g., location, date, etc.) received at step 902. If the one or more payment details (e.g., location, date, etc.) match one or more pieces of trip data (e.g., location, date, etc.) then the digital wallet device 104 may determine that the payment corresponds to a business transaction.

At step 908, the digital wallet device 104 transmits a business transaction notification to the user device 102. In some embodiments, the business transaction notification indicates that the payment of step 904 is identified as a business transaction. In some embodiments, the business transaction notification also comprises payment details (e.g., location related to the payment, time of the payment, goods/services associated with the payment, etc.) and/or a trip identifier associated with the business transaction.

At step 910, the user device 102 transmits a business transaction confirmation to the digital wallet device 104. In some embodiments, the user device 102 transmits the business transaction confirmation to the digital wallet device 104 in response to a user selecting an approval option related to the business transaction confirmation.

At step 912, the digital wallet device 104 associates the transaction with a trip identifier. For example, the digital wallet device 104 may add metadata corresponding to the trip identifier to payment details related to the payment of step 904.

At step 914, the user device 102 transmits an expense report request to the digital wallet device 104. In some embodiments, the expense report request comprises the trip identifier. For example, the expense report request may request the generation of an expense report of all payments related to the first trip identifier.

At step 916, the digital wallet device 104 identifies one or more payments. In some embodiments, the digital wallet device 104 identifies one or more payments requested by the expense report request. For example, the expense report request may request the generation of an expense report of all payments related to a first trip identifier, and the digital wallet device 104 identifies all payments related to the first trip identifier. In some embodiments, the digital wallet device 104 also identifies payment information and/or memos associated with the one or more payments requested by the expense report request.

At step 918, the digital wallet device 104 transmits an expense report to the user device 102. In some embodiments, the expense report comprises the one or more payments identified at step 916. In some embodiments, the expense report also comprises payment information and/or one or more memos associated with the one or more payments identified at step 916.

At step 920, the user device 102 transmits an expense report approval to the digital wallet device 104. In some embodiments, the process 900 uses the same or similar methods described at step 818 above. At step 922, the digital wallet device 104 transmits the approved expense report. In some embodiments, the process 900 uses the same or similar methods described at step 820 above. At step 924, the digital wallet device 104 transmits an expense report submission notification to the user device 102. In some embodiments, the process 900 uses the same or similar methods described at step 822 above.

In one embodiment, a transaction that is designated as a business transaction can be automatically posted or sent to a database associated with an expense report management tool via one or more API calls if the digital wallet device 104 and the expense report management tool are configured to communicate and share data. The expense report management tool receives a TRIP ID associated with the transaction records written to one or more databases associated with the expense report management tool, which allows the generation of expense reports for a particular trip ID (e.g., The Texas business trip). Similarly, all the designated business transactions can be written to the database(s) associated with the expense report management tool at the end of the trip, either automatically (e.g., if the end date of the business trip is known, in response to a user input, etc.). For example, a digital wallet application on a user device may enable the user to share or post business transaction details to the expense report management database, if the user is authorized to connect their digital wallet profile to the expense report. Transaction details can be posted on a transaction-by-transaction basis (e.g., separate HTTP requests for every transaction) or can be written to the expense report management tool by batching all the API calls together into one HTTP request.

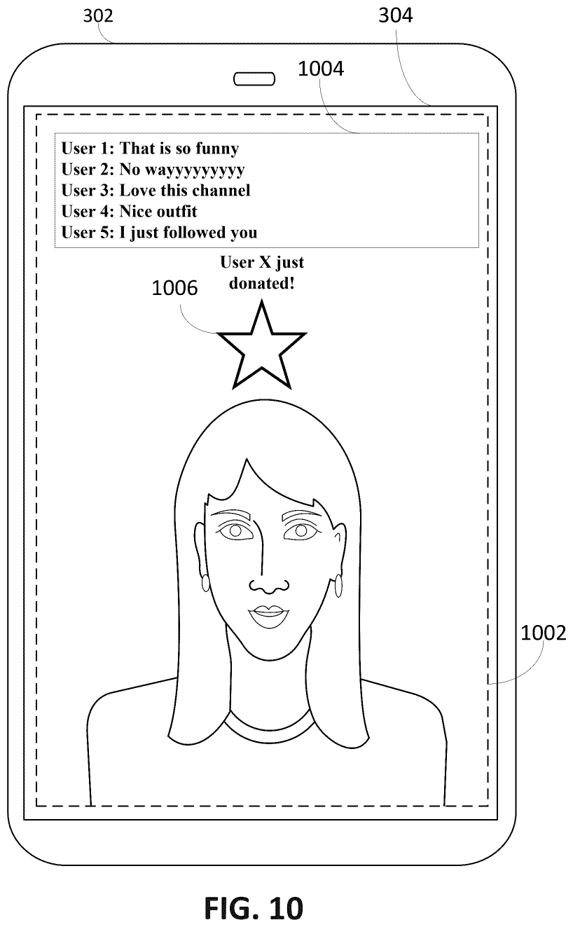

FIG. 10 shows an illustrative diagram of a user interface associated with a digital wallet system, in accordance with some embodiments of this disclosure. FIG. 10 shows the user device 302 displaying a third user interface 1002 on the display 304. In some embodiments, the third user interface 1002 comprises a chat box 1004 and a first media element 1006. In some embodiments, the chat box 1004 displays comments received from a plurality of users in real time. In some embodiments, the first media element 1006 is displayed in response to one or more users donating money.

In some embodiments, the comments of the chat box 1004 are slowed down or stopped in response to the first media element 1006. In some embodiments, the comments of the chat box 1004 are queued and then displayed after the first media element 1006 is displayed. In some embodiments, the comments of the chat box 1004 are slowed down or stopped in response to certain media elements (e.g., first media element 1006) with a value exceeding a threshold (e.g., 100$). For example, the comments of the chat box 1004 may be slowed down or stopped in response to the first media element 1006 with a value of 150$, but the comments of the chat box 1004 may not be slowed down or stopped in response to a second media element with a value of 2$. In some embodiments, the first media element 1006 comprises an animation that lasts a first time period (e.g., five seconds). In some embodiments, the comments of the chat box 1004 are slowed down or stopped until the animation of the first media element 1006 is finished. In some embodiments, non-donating users are unable to submit comments for display in the chat box 1004 for a time period. For example, commenting may be disabled for non-donating users until the animation of the first media element 1006 is finished. In some embodiments, the chat box 1004 changes size and/or shape in response to the first media element 1006. For example, the chat box 1004 may decrease in size until the animation of the first media element 1006 is finished.

In some embodiments, the system may recommend donations based on one or more stored preferences. For example, a first user may have a first digital wallet profile with a first preference (e.g., donating 1$ if a streamer mentions the name of the user). In some embodiments, the digital wallet profile recommends a donation to a user in response to one or more conditions of a preference being satisfied. In some embodiments, the system allows multiple users to pool their resources to donate enough money to satisfy a media element value threshold. For example, if the first media element 1006 has a value of 150$ then a first user may donate 100$ and a second user may donate 50$.

In some embodiments, the system may recommend donations based on historical donations and/or during specific moments of the live stream. In some embodiments, the system may recommend donations based on sentiment analysis of the user viewing the stream. For example, the user device 302 may determine if the user is very excited (e.g., high sentiment value) at a specific moment during the stream and display a donation recommendation. In some embodiments, the sentiment analysis occurs locally at the device. For example, the user device 302 may capture one or more pictures of the user's face and use one or more facial detection algorithms to detect the sentiment (e.g., happy) of the user.

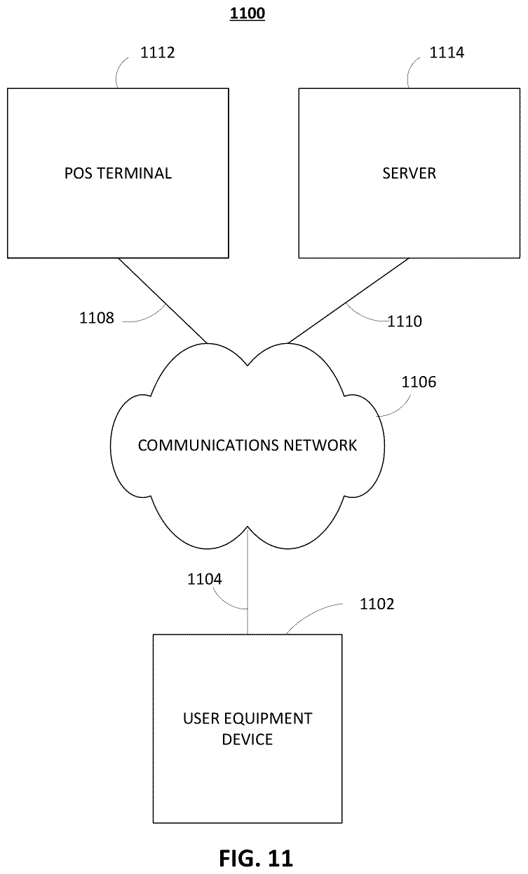

FIGS. 11-13 describe exemplary devices, systems, servers, and related hardware for providing a customizable digital wallet system that enables users to set their own preferences, in accordance with some embodiments. In the system 1100, there can be more than one user equipment device 1102 but only one is shown in FIG. 11 to avoid overcomplicating the drawing. In addition, a user may utilize more than one type of user equipment device 1102 and more than one of each type of user equipment device. In an embodiment there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices may also communicate with each other directly through an indirect path via the communications network 1106.

The user equipment devices may be coupled to communications network 1106. Namely, the user equipment device 1102 is coupled to the communications network 1106 via communications path 1104. The communications network 1106 may be one or more networks including the Internet, a mobile phone network, mobile voice or data network (e.g., a 4G, 5G, or LTE network), cable network, public switched telephone network, or other types of communications network or combinations of communications networks. The communications path 1104 may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In one embodiment communications path 1104 can be a wireless path. Communication with the user equipment device may be provided by one or more communications paths but is shown as a single path in FIG. 11 to avoid overcomplicating the drawing.

The system 1100 also includes a POS terminal 1112 and a server 1114, which can be coupled to any number of databases providing information to the user equipment devices. For example, the server 1114 may have access to calendar data, tipping customs data, location data, user information, encryption data, and/or similar such information. The server 1114 may store and execute various software modules for the providing of a customizable digital wallet system that enables users to set their own preferences functionality. In the system 1100, there can be more than one server 1114 but only one is shown in FIG. 11 to avoid overcomplicating the drawing. In addition, the system 1100 may utilize more than one type of server 1114 and more than one of each type of server.

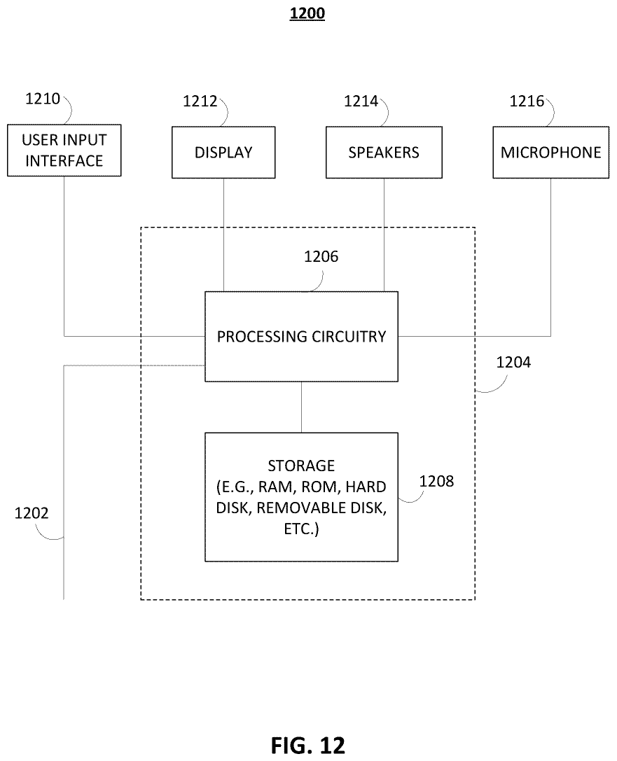

FIG. 12 shows a generalized embodiment of a user equipment device 1200, in accordance with some embodiments. In some embodiments, the user equipment device 1200 is an example of the user equipment devices described in FIGS. 1-11 (e.g., user device 102, user equipment device 1102). The user equipment device 1200 may receive content and data via input/output (I/O) path 1202. The I/O path 1202 may provide audio content (e.g., broadcast programming, on-demand programming, Internet content, content available over a local area network (LAN) or wide area network (WAN), and/or other content) and data to control circuitry 1204, which includes processing circuitry 1206 and a storage 1208. The control circuitry 1204 may be used to send and receive commands, requests, and other suitable data using the I/O path 1202. The I/O path 1202 may connect the control circuitry 1204 (and specifically the processing circuitry 1206) to one or more communications paths. I/O functions may be provided by one or more of these communications paths but are shown as a single path in FIG. 12 to avoid overcomplicating the drawing.

The control circuitry 1204 may be based on any suitable processing circuitry such as the processing circuitry 1206. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The providing of a customizable digital wallet system that enables users to set their own preferences functionality can be at least partially implemented using the control circuitry 1204. The providing of a customizable digital wallet system that enables users to set their own preferences functionality described herein may be implemented in or supported by any suitable software, hardware, or combination thereof.

In client-server-based embodiments, the control circuitry 1204 may include communications circuitry suitable for communicating with one or more servers that may at least implement the described providing of a customizable digital wallet system that enables users to set their own preferences functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 1208 that is part of the control circuitry 1204. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 1208 may be used to store various types of content described herein. Nonvolatile memory may also be used (e.g., to launch a boot-up routine and other instructions). Cloud-based storage, described in relation to FIG. 11 may be used to supplement the storage 1208 or instead of the storage 1208.

The control circuitry 1204 may include audio generating circuitry and tuning circuitry, such as one or more analog tuners, audio generation circuitry, filters or any other suitable tuning or audio circuits or combinations of such circuits. The control circuitry 1204 may also include scaler circuitry for upconverting and down converting content into the preferred output format of the user equipment device 1200. The control circuitry 1204 may also include digital-to-analog converter circuitry and analog-to-digital converter circuitry for converting between digital and analog signals. The tuning and encoding circuitry may be used by the user equipment device 1200 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 1208 is provided as a separate device from the user equipment device 1200, the tuning and encoding circuitry (including multiple tuners) may be associated with the storage 1208.

The user may utter instructions to the control circuitry 1204, which are received by the microphone 1216. The microphone 1216 may be any microphone (or microphones) capable of detecting human speech. The microphone 1216 is connected to the processing circuitry 1206 to transmit detected voice commands and other speech thereto for processing. In some embodiments, voice assistants (e.g., Siri, Alexa, Google Home and similar such voice assistants) receive and process the voice commands and other speech.

The user equipment device 1200 may optionally include an interface 1210. The interface 1210 may be any suitable user interface, such as a remote control, mouse, trackball, keypad, keyboard, touch screen, touchpad, stylus input, joystick, or other user input interfaces. A display 1212 may be provided as a stand-alone device or integrated with other elements of the user equipment device 1200. For example, the display 1212 may be a touchscreen or touch-sensitive display. In such circumstances, the interface 1210 may be integrated with or combined with the microphone 1216. When the interface 1210 is configured with a screen, such a screen may be one or more of a monitor, a television, a liquid crystal display (“LCD”) for a mobile device, active-matrix display, cathode ray tube display, light-emitting diode display, organic light-emitting diode display, quantum dot display, or any other suitable equipment for displaying visual images. In some embodiments, the interface 1210 may be HDTV-capable. In some embodiments, the display 1212 may be a 3D display. A speaker 1214 may be controlled by the control circuitry 1204. The speaker (or speakers) 1214 may be provided as integrated with other elements of user equipment device 1200 or may be a stand-alone unit. In some embodiments, the display 1212 may be outputted through speaker 1214.

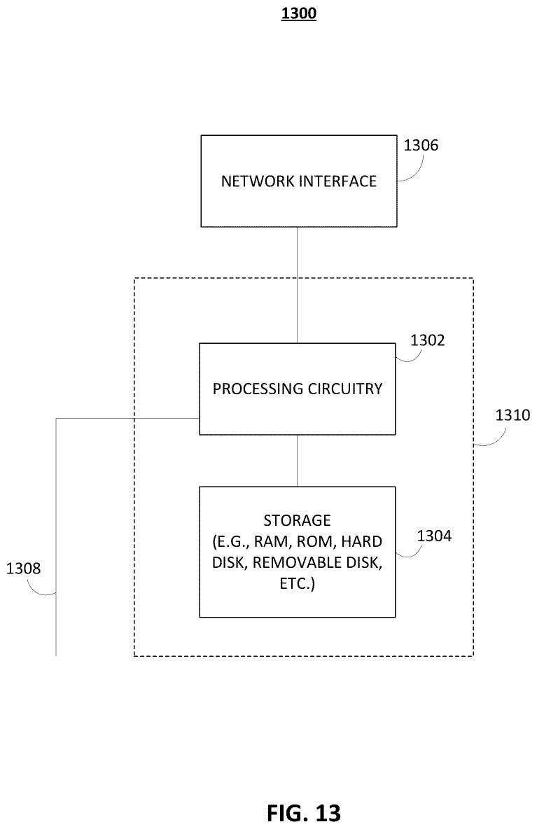

FIG. 13 shows an illustrative block diagram of a server system 1300, in accordance with some embodiments of the disclosure. Server system 1300 may include one or more computer systems (e.g., computing devices), such as a desktop computer, a laptop computer, and a tablet computer. In some embodiments, the server system 1300 is a data server that hosts one or more databases (e.g., databases of digital wallet profiles), models, or modules or may provide various executable applications or modules. In practice, and as recognized by those of ordinary skill in the art, items shown separately could be combined and some items could be separated. In some embodiments, not all shown items must be included in server system 1300. In some embodiments, server system 1300 may comprise additional items.

The server system 1300 can include processing circuitry 1302 that includes one or more processing units (processors or cores), storage 1304, one or more network or other communications network interfaces 1306, and one or more I/O paths 1308. I/O paths 1308 may use communication buses for interconnecting the described components. I/O paths 1308 can include circuitry (sometimes called a chipset) that interconnects and controls communications between system components. Server system 1300 may receive content and data via I/O paths 1308. The I/O path 1308 may provide data to control circuitry 1310, which includes processing circuitry 1302 and a storage 1304. The control circuitry 1310 may be used to send and receive commands, requests, and other suitable data using the I/O path 1308. The I/O path 1308 may connect the control circuitry 1310 (and specifically the processing circuitry 1302) to one or more communications paths. I/O functions may be provided by one or more of these communications paths but are shown as a single path in FIG. 13 to avoid overcomplicating the drawing.

The control circuitry 1310 may be based on any suitable processing circuitry such as the processing circuitry 1302. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 1304 that is part of the control circuitry 1310. Storage 1304 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 1304 or the computer-readable storage medium of the storage 1304 stores an operating system, which includes procedures for handling various basic system services and for performing hardware dependent tasks. In some embodiments, storage 1304 or the computer-readable storage medium of the storage 1304 stores a communications module, which is used for connecting the server system 1300 to other computers and devices via the one or more communication network interfaces 1306 (wired or wireless), such as the internet, other wide area networks, local area networks, metropolitan area networks, and so on. In some embodiments, storage 1304 or the computer-readable storage medium of the storage 1304 stores a web browser (or other application capable of displaying web pages), which enables a user to communicate over a network with remote computers or devices. In some embodiments, storage 1304 or the computer-readable storage medium of the storage 1304 stores a database for calendar data, tipping customs data, location data, user information, encryption data, and/or similar such information.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise rearranged in various implementations. In some embodiments, the storage 1304 stores a subset of the modules and data structures identified above. In some embodiments, the storage 1304 may store additional modules or data structures not described above.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1-40. (canceled)

41. A method comprising:
receiving a set of preferences corresponding to a digital wallet profile, wherein a first preference of the set of preferences corresponds to a tipping percentage;
receiving a first payment request from a first device, wherein:
the first payment request is associated with a purchase; and
the first payment request comprises a digital wallet profile identifier;
identifying the digital wallet profile using the digital wallet profile identifier;
transmitting a payment confirmation, wherein the payment confirmation comprises:
first payment information; and
a transaction code;
receiving a second payment request from the first device, wherein:
the second payment request corresponds to a tip related to the purchase; and
the second payment request comprises the digital wallet profile identifier and the transaction code;
determining that the second payment request is associated with the first payment request based, at least in part, on the second payment request comprising the transaction code;
identifying the tipping percentage using the digital wallet profile identifier;
calculating a tip amount based, at least in part, on the tipping percentage; and
transmitting a tipping confirmation, wherein the tipping confirmation comprises:
the tip amount;
second payment information; and
the transaction code.

42. The method of claim 41, wherein:
receiving the first payment request from the first device is based, at least in part, on a second device transmitting payment details to the first device; and
receiving the second payment request from the first device is based, at least in part, on the second device transmitting tip details to the first device.

43. The method of claim 42, wherein the first payment information and the second payment information correspond to the same credit card.

44. The method of claim 42, wherein the first payment information corresponds to a first credit card and the second payment information corresponds to a second credit card different from the first credit card.

45. The method of claim 42, further comprising transmitting, by the first device, a batch authorization comprising a total price, wherein the total price corresponds to the sum of the tip amount and the purchase.

46. The method of claim 45, wherein the batch authorization further comprises the first payment information and the second payment information.

47. The method of claim 42, further comprising receiving a digital receipt from the first device, and wherein a second preference of the set of preferences corresponds to digital receipt preference.

48. The method of claim 42, wherein:
the second device transmits payment details to the first device using a near-field communication protocol; and
the second device transmits tip details to the first device using the near-field communication protocol.

49. The method of claim 42, further comprising receiving, from the first device, purchase information related to the purchase, wherein:
the first preference indicates a location associated with the tipping percentage;
the purchase information comprises the location related to the purchase; and
identifying the tipping percentage is based, at least in part, on determining that the location related to the purchase matches the location associated with the tipping percentage.

50. The method of claim 42, further comprising:
receiving, from the first device, purchase information related to the purchase;
determining that the purchase information corresponds to a first transaction type based, at least in part, on the purchase information, wherein:
the first preference indicates a first transaction type associated with the tipping percentage; and
identifying the tipping percentage is based, at least in part, on determining that the first transaction type related to the purchase matches the first transaction type associated with the tipping percentage.

51. An apparatus, comprising:
control circuitry; and
at least one memory including computer program code for one or more programs, the at least one memory and the computer program code configured to, with the control circuitry, cause the apparatus to perform at least the following:
receive a set of preferences corresponding to a digital wallet profile, wherein a first preference of the set of preferences corresponds to a tipping percentage;
receive a first payment request from a first device, wherein:
the first payment request is associated with a purchase; and
the first payment request comprises a digital wallet profile identifier;
identify the digital wallet profile using the digital wallet profile identifier;
transmit a payment confirmation, wherein the payment confirmation comprises:
first payment information; and
a transaction code;
receive a second payment request from the first device, wherein:
the second payment request corresponds to a tip related to the purchase; and
the second payment request comprises the digital wallet profile identifier and the transaction code;
determine that the second payment request is associated with the first payment request based, at least in part, on the second payment request comprising the transaction code;
identify the tipping percentage using the digital wallet profile identifier;
calculate a tip amount based, at least in part, on the tipping percentage; and
transmit a tipping confirmation, wherein the tipping confirmation comprises:
the tip amount;
second payment information; and
the transaction code.

52. The apparatus of claim 51, wherein:
the apparatus is caused to receive the first payment request from the first device based, at least in part, on a second device transmitting payment details to the first device; and
the apparatus is caused to receive the second payment request from the first device based, at least in part, on the second device transmitting tip details to the first device.

53. The apparatus of claim 52, wherein the first payment information and the second payment information correspond to the same credit card.

54. The apparatus of claim 52, wherein the first payment information corresponds to a first credit card and the second payment information corresponds to a second credit card different from the first credit card.

55. The apparatus of claim 52, wherein the first device is caused to transmit a batch authorization comprising a total price based, at least in part on the apparatus being caused to transmit the tipping confirmation, wherein the total price corresponds to the sum of the tip amount and the purchase.

56. (canceled)

57. The apparatus of claim 52, wherein the apparatus is further caused to receive a digital receipt from the first device, and wherein a second preference of the set of preferences corresponds to digital receipt preference.

58. The apparatus of claim 52, wherein:
the second device transmits payment details to the first device using a near-field communication protocol; and
the second device transmits tip details to the first device using the near-field communication protocol.

59. The apparatus of claim 52, wherein the apparatus is further caused to receive, from the first device, purchase information related to the purchase, wherein:
the first preference indicates a location associated with the tipping percentage;
the purchase information comprises the location related to the purchase; and
the apparatus being caused to identify the tipping percentage is based, at least in part, on the apparatus being caused to determine that the location related to the purchase matches the location associated with the tipping percentage.

60. The apparatus of claim 52, wherein the apparatus is further caused to:
receive, from the first device, purchase information related to the purchase;
determine that the purchase information corresponds to a first transaction type based, at least in part, on the purchase information, wherein:
the first preference indicates a first transaction type associated with the tipping percentage; and
the apparatus being caused to identify the tipping percentage is based, at least in part, on the apparatus being caused to determine that the first transaction type related to the purchase matches the first transaction type associated with the tipping percentage.

61. A non-transitory computer-readable medium having instructions encoded thereon that, when executed by control circuitry, cause the control circuitry to:
receive a set of preferences corresponding to a digital wallet profile, wherein a first preference of the set of preferences corresponds to a tipping percentage;
receive a first payment request from a first device, wherein:
the first payment request is associated with a purchase; and
the first payment request comprises a digital wallet profile identifier;
identify the digital wallet profile using the digital wallet profile identifier;
transmit a payment confirmation, wherein the payment confirmation comprises:
first payment information; and
a transaction code;
receive a second payment request from the first device, wherein:
the second payment request corresponds to a tip related to the purchase; and
the second payment request comprises the digital wallet profile identifier and the transaction code;
determine that the second payment request is associated with the first payment request based, at least in part, on the second payment request comprising the transaction code;
identify the tipping percentage using the digital wallet profile identifier;
calculate a tip amount based, at least in part, on the tipping percentage; and
transmit a tipping confirmation, wherein the tipping confirmation comprises:
the tip amount;
second payment information; and
the transaction code.

62.-80. (canceled)
